(19) United States
(12) Patent Application Publication
(10) Pub. No.: US 2019/0124402 A1
(43) Pub. Date: Apr. 25, 2019

(54) INFORMATION PROVISION DEVICE, RECEPTION DEVICE, INFORMATION PROVISION SYSTEM, INFORMATION PROVISION METHOD AND PROGRAM

(71) Applicant: SHARP KABUSHIKI KAISHA, Sakai City, Osaka (JP)

(72) Inventor: YOSHINORI NAGAI, Sakai City (JP)

(73) Assignee: SHARP KABUSHIKI KAISHA, Sakai City, Osaka (JP)

(21) Appl. No.: 16/092,185

(22) PCT Filed: Feb. 16, 2017
(86) PCT No.: PCT/JP2017/005693

§ 371 Date: Oct. 8, 2018

(30) Foreign Application Priority Data
Apr. 12, 2016 (JP) 2016-079906

(51) Int. Cl. H04N 21/482; H04N 21/442

(52) U.S. Cl. CPC H04N 21/4826; H04N 21/4828; H04N 21/44222; H04N 21/4821; H04N 21/4823

(57) ABSTRACT

A determination unit determines candidates for recommendation content from content scheduled to be transmitted based on a viewing history of received content received by a reception device. A creation unit determines an effective period corresponding to the service type of a reception service of the recommendation content and transmits recommendation content information created including the effective period to the reception device.

### TECHNICAL FIELD

Some embodiments of the present invention relate to an information provision device, a reception device, an information provision system, an information provision method and a program.

Priority is claimed on Japanese Patent Application No. 2016-079906, filed Apr. 12, 2016, the content of which is incorporated herein by reference.

### BACKGROUND ART

Conventionally, information provision systems which analyze reception device utilization histories and provide information of content in response to preferences of users have been proposed. There are information provision systems which limit provision of information about invalid content.

For example, Patent Document 1 discloses an effective period management system in which a server manages a terminal, each function of the terminal and an effective period of each piece of content, and the terminal receives an effective period update command from a server, stores an updated effective period for each function and, when the current date and time are within an effective period for one of the terminal, each function of the terminal and access to content, one of the terminal, each function of the terminal and access of content can be started.

In addition, Patent Document 2 discloses a recording and reproduction device which calculates remaining times until viewing limit times of unseen content when a screen on which a content list recorded by a user is displayed is open and, when there is content whose viewing limit time expires within a predetermined time, preferentially displays the content at a location conspicuous to the user while the content list is displayed.

### PRIOR ART DOCUMENTS

### Patent Documents

[Patent Document 1] PCT International Publication No. 02/13028
[Patent Document 2] Japanese Unexamined Patent Application, First Publication No. 2009-260670

### SUMMARY OF THE INVENTION

### Problem to Be Solved by the Invention

Meanwhile, a card operation type reception device which displays a card type image representing recommended content and starts a function of receiving selected content according to an operation applied to the display area of the image has been proposed. However, the card operation type reception device does not perform control of not-displaying images representing content whose effective period has expired and images with respect to content whose effective period does not expire. Even when the effective period of content displayed in an image does not expire or has expired, an operation may be performed on the image. Accordingly, the card operation reception device cannot receive selected content according to an operation. Furthermore, an unintended operation of a user may occur or an inconsistency may occur in an operation.

An object of some embodiments of the present invention devised in view of the aforementioned circumstances is to provide an information provision device, a reception device, an information provision system, an information provision method and a program capable of reliably receiving content represented by a displayed image.

### Means for Solving the Problems

Some aspects of the present invention are made to solve the above-described problem. One aspect of the present invention is an information provision device including: a determination unit which determines candidates for recommendation content from content scheduled to be transmitted based on a viewing history of received content received by a reception device; and a creation unit which determines an effective period corresponding to the service type of a reception service of the recommendation content and transmits recommendation content information created including the effective period to the reception device.

### Effect of the Invention

According to some embodiments of the present invention, it is possible to reliably receive content represented by a displayed image.

### BRIEF DESCRIPTION OF THE DRAWINGS

FIG. 1 is a schematic block diagram illustrating an information provision system according to a first embodiment.

FIG. 2 is a diagram illustrating an example of channel selection information.

FIG. 3 is a diagram illustrating an example of channel correspondence information.

FIG. 4 is a diagram illustrating an example of program information.

FIG. 5 is a diagram illustrating an example of setting the number of programs for each genre.

FIG. 6 is a diagram illustrating an example of selecting recommended content.

FIG. 7 is a diagram illustrating an example of setting ranks of recommended content.

FIG. 8 illustrates an example of collecting card information for each card acquisition unit time.

FIG. 9 is a diagram illustrating an example of card information.

FIG. 10 is a diagram illustrating an example of displaying an image representing content information.

FIG. 11 is a diagram illustrating an example of display ranks.

FIG. 12 is a sequence diagram illustrating an example of an information provision procedure according to the first embodiment.

FIG. 13 is a schematic block diagram illustrating an example of an information provision system according to a second embodiment.

FIG. 14 is a diagram illustrating an example of the number of selections of a program for each recommendation type.

FIG. 15 is a diagram illustrating an example of life time period information and a content addition time period.

FIG. 16 is a diagram illustrating an example of selecting recommended content.

FIG. 17 is a sequence diagram illustrating an example of an information provision process according to the second embodiment.

### EMBODIMENTS FOR CARRYING OUT THE INVENTION

### First Embodiment

Hereinafter, a first embodiment of the present invention will be described.

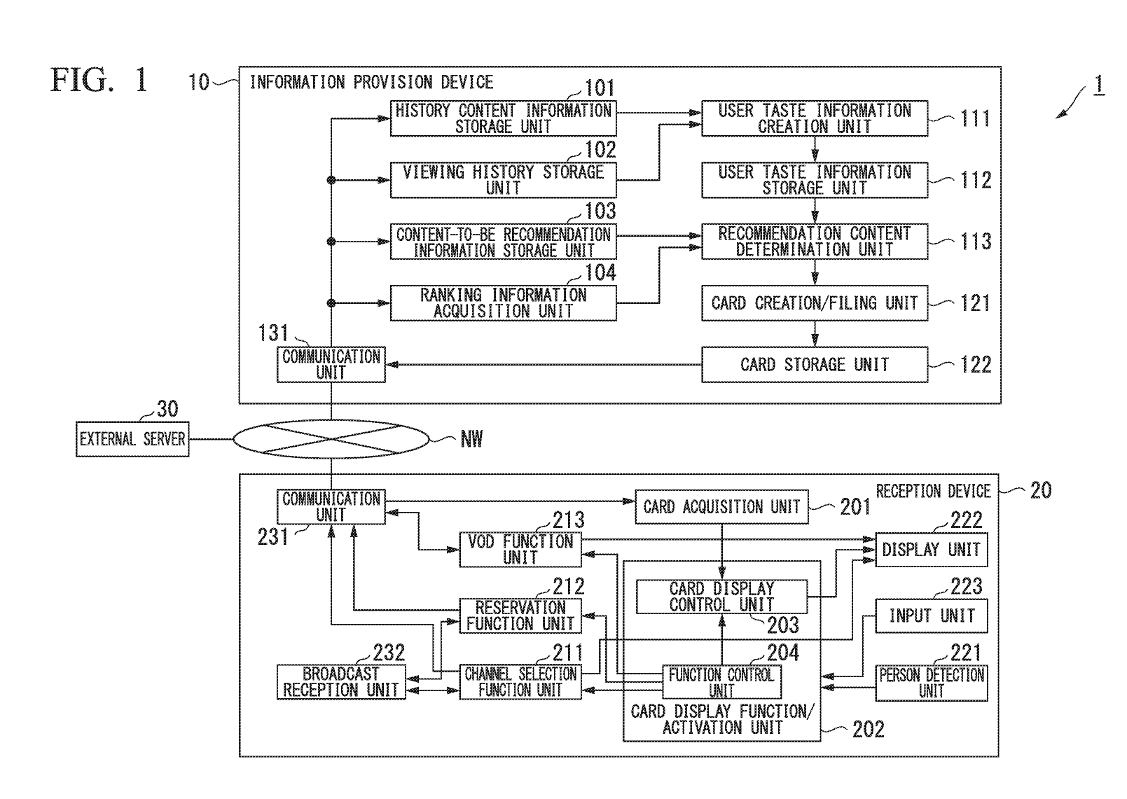

FIG. 1 is a schematic block diagram illustrating an information provision system 1 according to a first embodiment of the present invention. The information provision system 1 includes an information provision device 10, a reception device 20 and an external server 30. The information provision device 10, the reception device 20 and the external server 30 may be connected to a network NW and transmit/receive various types of data in a wired or wireless manner to/from each other. For example, the network NW is a two-way information communication network including any one of a wide area network (WAN) such as the Internet or a public wireless communication network, a local area network (LAN), a virtual private network (VPN) and the like, or a combination thereof.

The information provision device 10 receives content information about content scheduled to be transmitted from the external server 30. The information provision device 10 determines content selected from content scheduled to be transmitted having an attribute which is the same as for content received by the reception device 20 based on a degree of the attribute or the quantity of reception as recommended content. Here, the information provision device 10 ideally uses content actually viewed by a user and the actual quantity of viewing as well as information received by the reception device 20 instead of the received content and the quantity of reception. However, it is not easy to determine whether the user is actually viewing a program which is being received by the reception device 20, in general. In the following description, viewing may mean reception. That is, it is assumed that viewed content is received content and the quantity of viewing is the quantity of reception. Further, the reception device 20 may include a human detection sensor and a line-of-sight detection unit (not shown) which detects a line of sight from a captured image of the user, for example. When the direction of a detected line of sight faces a display unit 222 (which will be described later) displaying received content, the reception device 20 may determine that the received content as actual viewed content and detect the quantity of viewing based on a period for which the line of sight has faced that direction. The information provision device 10 may use a viewing history indicating the viewed content and the quantity of viewing. Content is any one of a video, audio, text and the like or a combination thereof. For example, content is a television broadcast program, video-on demand (VOD) content, an advertisement video, music and the like. Hereinafter, a case in which content is a television broadcast program or VOD content will be mainly described. In addition, a television broadcast program is called a program. Television broadcast and a VOD service which are provision forms are respectively called broadcast and VOD. The VOD service is a service of acquiring content at the request of a user through communication. Recommended content refers to content which is a recommendation target of each reception device 20 for a user. In the following description, recommended content may be called recommendation content. A user that is a destination of provision of a recommendation target may be a number of unspecified users or a specific user for which a predetermined contract has been concluded.

Prices pertaining to services or transactions may be charged or free.

The information provision device 10 determines a term in which a reception service with respect to recommendation content can be provided as an effective period through a function of the reception device 20 with respect to the recommendation content. In the following description, a case in which there are three types of recommendation content reception service: broadcast, reservation and VOD, is exemplified. An effective period depends on a service type. The information provision device 10 creates card information for each predetermined period as an example of recommended content information including reception information used to receive the recommendation content and the effective period. Then, the information provision device 10 transmits the created card information to the reception device 20 through communication. For example, the information provision device 10 may be a server device used by an information provider, a broadcaster, a content provider or an information provider that received requests therefrom.

The reception device 20 executes a process relating to a reception service with respect to recommendation content. The process relating to the reception service with respect to the recommendation content includes receiving broadcast waves of a channel through which a program is broadcast when the recommended content is a program or receiving and recording the recommendation content at a reservation time designated by the user. The reception device 20 acquires card information including reception information with respect to reception and the effective period of the corresponding recommendation content. For example, the reception information with respect to reception of the recommendation content includes a channel of broadcast waves carrying data and a reception time when the recommendation content is a program. When the recommendation content is VOD content, the reception information with respect to reception includes an address, a file name and the like of a server device in which data of the recommendation content is stored, for example. In addition, the reception device 20 controls whether to output an image representing the recommendation content according to whether the recommendation content is within the effective period. The reception device 20 executes a function relating to reception of the recommendation content according to an instruction through an operation performed on the image representing the recommendation content. For example, the reception device 20 receives broadcast waves based on the reception information, acquires program data carried by the received broadcast waves and outputs video data included in the acquired program data to a display unit. For example, the reception device 20 is a terminal device such as a set-top box. Although one reception devices 20 is illustrated in FIG. 1, there are a plurality of reception devices 20 in general.

The external server 30 is a server device which transmits various types of information to the information provision device 10. The external server 30 is a general term for a server device separate from the information provision device 10. There may be a plurality of external servers 30. For example, the external server 30 may include a program integration server, a VOD content integration server, a ranking server, a VOD content server and the like.

The program integration server is a server device which acquires program information of each of programs scheduled to be broadcast and broadcast programs with respect to each channel from server devices of broadcast providers and integrates acquired program information. The program integration server is a server device of an electronic program guide (EPG) provider. The program integration server transmits newly acquired program information about a program scheduled to be broadcast to the information provision device 10 for each predetermined time (for example, 1 day). In addition, the program integration server transmits program information about a broadcast program to the information provision device 10.

The VOD content integration server is a server device which integrates VOD content information about transmittable VOD content and transmitted VOD content sequentially acquired from server devices of content providers. The VOD content integration server transmits newly acquired VOD content information to the information provision device 10 for each predetermined time (for example, 1 day). In addition, the VOD content integration server transmits VOD content information about VOD content which has been transmitted to any reception device 20 to the information provision device 10. Meanwhile, in the following description, meta information of content such as program information and VOD content information is generally called content information. Server devices which provide content information, such as the program integration server and the VOD content integration server are generally called a content information server. The content information server may transmit content information about content which has been transmitted according to a transmission request from the information provision device 10 or transmit the content information at any time.

The ranking server is a server device which acquires channel selection information from each reception device 20 and integrates acquired channel selection information. Channel selection information is information including a program received by the reception device 20 through channel selection and the reception time. The ranking server calculates an audience rating of each program broadcast through each channel for each predetermined unit time with respect to programs. The ranking server creates ranking information representing a ranking obtained by ordering audience ratings calculated with respect to programs within a unit time in descending order. An audience rating is a proportion of the number of reception devices which receive a noted program among all reception devices which are service targets.

The ranking server is a server device which acquires VOD channel selection information from each reception device 20 and integrates acquired VOD channel selection information. VOD channel selection information is information including VOD content selected by the reception device 20 and a viewing time. Here, the viewing time refers to a time for which the corresponding video has been displayed. The ranking server counts the number of receptions for each piece of VOD content with respect to VOD content and creates ranking information representing a ranking obtained by ordering the counted numbers of receptions in descending order. A period in which the number of receptions is counted may be a period from a time at which each VOD content has been transmittable to that time or a period of a predetermined duration the same as for transmittable content (e.g., one month to that time). The ranking server transmits the created ranking information to the information provision device 10.

The VOD content server is a server device which stores content data of various types of VOD content. The VOD content server reads content data of VOD content indicated by a VOD content request received from the reception device 20. The content data is data including video data constituting VOD content. The VOD content server transmits the read content data to the reception device 20 which is the transmission source as a response to VOD content request.

### (Configuration of Information Provision Device)

Next, the configuration of the information provision device 10 according to the present embodiment will be described.

The information provision device 10 includes a history content information storage unit 101, a viewing history storage unit 102, a content-to-be-recommended information storage unit 103, a ranking information acquisition unit 104, a user taste information creation unit 111, a user taste information storage unit 112, a recommendation content determination unit 113, a card creation/filing unit 121, a card storage unit 122 and a communication unit 131.

The history content information storage unit 101 acquires content information from the external server 30 through the communication unit 131 and stores the acquired content information. The content information acquired by the history content information storage unit 101 is content information about content received by the reception device 20 in the past. For example, the history content information storage unit 101 acquires program information as content information from the program integration server. Program information is formed as metadata representing information including a program identifier (ID), a broadcast start time, a broadcast end time, a broadcast station name, a program name, a genre (field) and cast (performers) for each program, for example, as shown in FIG. 4. The broadcast start time and the broadcast end time is information representing a broadcast time. In addition, the history content information storage unit 101 acquires VOD content information as content information from the VOD content integration server, for example. For example, VOD content information is formed as metadata representing information including a content ID, acquisition destination information, a play time, a publication start time, a publication end time, a producer name, a provider name, a title, a genre and cast for each VOD content. For example, the acquisition destination information is a uniform resource locator (URL) of a VOD content server device capable of transmitting the VOD content, and the like. The URL also includes information of a directory of a storage destination of VOD content data of the VOD content. The publication start time and the publication end time are a time at which a state in which the VOD content is transmittable starts and a time at which the transmittable state ends in the server device. The history content information storage unit 101 includes a storage medium such as a random access memory (RAM).

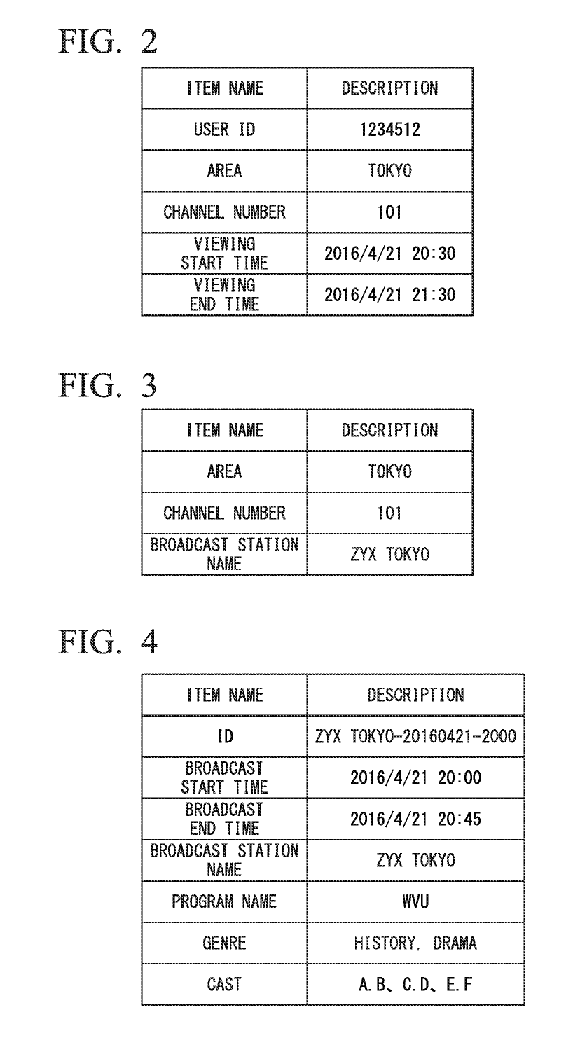

The viewing history storage unit 102 acquires channel selection information from the reception device 20 through the communication unit 131 and sequentially stores acquired channel selection information to form a program viewing history for each reception device 20. For example, channel selection information is information including a user ID, an area, a channel number, a viewing start time and a viewing end time, as shown in FIG. 2. The user ID is information which identifies the user of the reception device 20. A device ID of the reception device 20 may be used instead of the user ID. The area is an area in which the corresponding program is broadcast. The channel number is the number of the channel through which the corresponding program is broadcast. The viewing start time and the viewing end time represent a reception time at which the program is received.

There are cases in which the viewing start time or the viewing end time is a time within the broadcast time of the program. Such cases include a case in which the user instructs the program to be switched to another program, a case in which another program is inserted into one program, and the like. Accordingly, broadcast times of certain programs do not necessarily have a one-to-one correlation with reception times.

The viewing history storage unit 102 identifies a broadcast station name corresponding to an area and a channel number indicated by channel selection information as a broadcast station broadcasting a corresponding program with reference to channel correspondence information stored in advance therein. The channel correspondence information is information formed by correlating an area, a channel number and a broadcast station name, as shown in FIG. 3.

In addition, the viewing history storage unit 102 may identify a program name which is consistent with the identified broadcast station name and relates to a program whose reception time is included in a broadcast time as a program name of a program received within the reception time.

Further, the viewing history storage unit 102 sequentially stores VOD selection information acquired from the reception device 20 to form a VOD viewing history for each reception device 20. VOD selection information is information including a user ID, a content ID, a viewing start time and a viewing end time. The content ID is information identifying each piece of VOD content.

The content-to-be-recommended information storage unit 103 acquires content information about content which is likely to be recommended from the external server 30 through the communication unit 131 and stores program information and VOD content information as the acquired content information and VOD content information. Here, when programs are exemplified, it is desirable that the content which is likely to be recommended is a program scheduled to be broadcast in a certain period of time in the future, such as two days from 05:00 next morning to 05:00 two days later. A recommended program is selected from programs scheduled to be broadcast in that period. Program information is sequentially stored in the content-to-be-recommended information storage unit 103 according to channels and a broadcast time to form EPG information as a part of content-to-be-recommended information. The program information acquired by the content-to-be-recommended information storage unit 103 is program information about programs scheduled to be broadcast in the future, and thus the content-to-be-recommended information storage unit 103 differs from the history content information storage unit 101 which acquires program information about programs which have been viewed. After broadcasting of a program is finished, the content-to-be-recommended information storage unit 103 duplicates (copies) program information of the program, stores the copied program information in the history content information storage unit 101 and deletes the program information stored therein. In such a case, the program integration server which is the external server 30 may omit transmission of the program information about the program which has been broadcast to the information provision device 10.

The VOD content information acquired by the content-to-be-recommended information storage unit 103 is VOD content information about VOD content which can be transmitted in the future, and thus the content-to-be-recommended information storage unit 103 differs from the history content information storage unit 101 which acquires VOD content information about VOD which has been viewed. The content-to-be-recommended information storage unit 103 may copy VOD content information about VOD content received in any reception device 20 and store the VOD content information in the history content information storage unit 101. The content-to-be-recommended information storage unit 103 may identify the reception device 20 which has received the VOD content and the received VOD content with reference to VOD viewing history stored in the viewing history storage unit 102. In such a case, the VOD content integration server may omit transmission of VOD content information about VOD content which has been transmitted to the information provision device 10. When the current time exceeds a predetermined transmission period in the VOD content, the content-to-be-recommended information storage unit 103 deletes the VOD content information stored therein. Information on the predetermined transmission period may be included in the VOD content information. Alternatively, the publication start time and the publication end time may be used as transmission period information.

The ranking information acquisition unit 104 acquires ranking information from the external server 30 through the communication unit 131. Content having a high ranking indicated by the acquired ranking information refers to popular content. With respect to ranking information about programs, the ranking information acquisition unit 104 selects programs scheduled to be broadcast in the future which are so-called series programs from programs having rankings indicated by the ranking information which are higher than a predetermined ranking (e.g., third). Series programs are a group of programs which have at least a common program name and are regularly broadcast by the same broadcaster. The ranking information acquisition unit 104 identifies programs having a common program name and a common broadcast station name as series programs with reference to program information stored in the content-to-be-recommended information storage unit 103. At least one of a broadcast time period, a date and the cast or a combination thereof may be the same in the series programs. Whether a program is a series program is one attribute of the program.

With respect to ranking information about VOD content, the ranking information acquisition unit 104 also selects ranking information about VOD content having a ranking indicated by ranking information which is higher than a predetermined ranking (e.g., sixth) from the VOD content for which the current time is within a predetermined transmission period.

The ranking information acquisition unit 104 outputs selected ranking information to the recommendation content determination unit 113.

Further, the ranking information acquisition unit 104 may receive provider-recommended content information from the external server 30 along with or instead of ranking information with respect to VOD content. The provider-recommended content information is content information about VOD content for which a content provider or producer recommends reception.

The user taste information creation unit 111 reads a program viewing history of each reception device 20 from the viewing history storage unit 102 and reads program information on each program represented by the read program viewing history from the history content information storage unit 101. For each attribute with respect to a taste of a user, the user taste information creation unit 111 analyzes the quantity of viewing of a program having the attribute with reference to program information read from the history content information storage unit 101. There are a cast, a genre, a program name and the like as attributes with respect to a taste. For example, the user taste information creation unit 111 stores reception times of received programs in a predetermined cumulative period (e.g., one month) for each cast and calculates the quantity of viewing obtained through storage. With respect to genres and program names, the user taste information creation unit 111 also calculates the quantity of viewing for each genre and each program name through the same method as that used for the cast. The user taste information creation unit 111 aligns the quantity of viewing for each item (i.e., cast, genre and program name) with respect to each attribute type in descending order. The user taste information creation unit 111 may select the quantity viewing of each of a predetermined number of items (e.g., 5 items of the first to fifth ranks) for each attribute type from aligned quantities of viewing and reject quantities of viewing of other items. Accordingly, whether the user of the reception device 20 likes programs having any attribute is analyzed. The user taste information creation unit 111 creates user taste information representing a selected item of each attribute type for each reception device 20 and stores the created user taste information in the user taste information storage unit 112.

Further, with respect to VOD content, the user taste information creation unit 111 also creates user taste information for each reception device 20 and stores the created user taste information in the user taste information storage unit 112 through the same method as that used for programs. Here, the user taste information creation unit 111 uses VOD viewing histories and VOD content information instead of program viewing histories and program information.

The user taste information storage unit 112 stores user taste information created by the user taste information creation unit 111. The user taste information storage unit 112 does not necessarily permanently store the user taste information and may temporarily store the user taste information. The user taste information may be eliminated after being used for determination of recommendation content in the recommendation content determination unit 113 (which will be described later).

The recommendation content determination unit 113 reads user taste information of each reception device 20 from the user taste information storage unit 112 and receives ranking information from the ranking information acquisition unit 104. The recommendation content determination unit 113 determines candidates for recommendation content from content with respect to content information stored in the content-to-be-recommended information storage unit 103 using the user taste information. Recommendation content is content recommended for the user of the reception device 20. Hereinafter, candidates for recommendation content will be called candidate content. The recommendation content determination unit 113 selects candidate content further using ranking information input from the ranking information acquisition unit 104 with respect to a ranking base time period. In the following description, determination of candidate content using user taste information may be called a viewing trend base and determination of candidate content using ranking information may be called a ranking base.

In the viewing trend base, the recommendation content determination unit 113 uses a predetermined recommendation type as a key and selects a program including elements consistent with an item with respect to the recommendation type in program information. In addition, the recommendation content determination unit 113 assigns a higher score to a program having a larger number of elements consistent with the item. Recommendation types are attribute types represented by user taste information or a combination thereof used to select candidate content. That is, a recommendation type is also a kind of content attribute. For example, recommendation types include a genre, a cast and regularity.

With respect to genres, the recommendation content determination unit 113 selects a program belonging to a genre consistent with a genre indicated by the user taste information as candidate content. Although one program may also be classified into a plurality of genres, the recommendation content determination unit 113 assigns a higher score to a program classified into a genre indicated by the user taste information more times.

With respect to cast, the recommendation content determination unit 113 assigns a higher score to a program having a larger size of cast consistent with casts indicated by the user taste information.

In addition, the recommendation content determination unit 113 selects programs having scores higher than a predetermined score for candidate content.

With respect to regularity, the recommendation content determination unit 113 selects series programs consistent with the genre and casts indicated by the user taste information as candidate content. The recommendation content determination unit 113 may identify programs having a common program name, a common broadcast station name and a regular broadcast time as series programs. “Regular” means the same time period in each of a predetermined number of days, for example. Each of a predetermined number of days means every day, a specific day of every week, or the like, for example. That is, regularity means an attribute having a common genre and cast and at least a regular broadcast time. With respect to regularity, the recommendation content determination unit 113 assigns a higher score to a program having a longer viewing time. Accordingly, a higher score is assigned to a program having a higher degree of suiting the taste of the user of the reception device 20.

Further, the recommendation content determination unit 113 may also select candidate content with respect to VOD content through the same method as that used for programs. However, the recommendation content determination unit 113 may not perform the process of selecting candidate content using regularity as a recommendation type with respect to VOD content.

In the ranking base, the recommendation content determination unit 113 selects, as candidate content, programs and VOD content as content indicated by ranking information input from the ranking information acquisition unit 104 and determines a higher score for content having a higher ranking indicated by the ranking information.

A score determined by the recommendation content determination unit 113 for each piece of content is a value normalized in a predetermined range (e.g., 0 to 100), for example. The predetermined range may be the same irrespective of the viewing trend base and the ranking base and may be the same irrespective of recommendation types.

Further, the recommendation content determination unit 113 may receive provider-recommended content information from the external server 30 along with or instead of the ranking information with respect to VOD content. The provider-recommended content information is content information about provider-recommended content which is VOD content recommended by a content provider or producer. The recommendation content determination unit 113 may select provider-recommended content as candidate content in preference to other pieces of VOD content. In such a case, the recommendation content determination unit 113 may assign a higher score to a provider-recommended content than VOD content which is other candidate content.

The recommendation content determination unit 113 creates recommendation content information representing a score of each piece of candidate content for each of pieces of candidate content determined on the viewing trend base and candidate content determined on the ranking base and outputs the created recommendation content information to the card creation/filing unit 121. With respect to the candidate content determined on the viewing trend base, the recommendation content determination unit 113 adds information on a recommendation type used to select the candidate content to the recommendation content information. In addition, the recommendation content determination unit 113 outputs content information of each piece of candidate content to the card creation/filing unit 121.

The card creation/filing unit 121 selects, as recommendation content, the same number of pieces of content as the number of pieces of predetermined card information which may be received and presented by one reception device 20 from candidate content represented by the recommendation content information input from the recommendation content determination unit 113 for each predetermined unit time (e.g., 30 minutes). This time period is based on a reception time at which the reception device 20 receives recommendation content. In the following description, this time period will be called a slot. Recommendation content is content recommended for the user of the reception device 20. The card creation/filing unit 121 preferentially selects recommendation content having a higher score with respect to each recommendation content service type. Service types refer to types of service form for the user of the reception device 20. For example, service types include broadcast, reservation and VOD. Broadcast refers to receiving program data of a program broadcast at one time and presenting content such as a video and an audio with respect to the received program data at that time. Reservation refers to performing reception and recording of program data of a program scheduled to be broadcast at an instructed time. VOD refers to requesting VOD content transmittable at one time, receiving VOD content data of the requested VOD content and presenting content with respect to the received VOD content data at that time. An example of selecting recommendation content will be described later.

The card creation/filing unit 121 creates card information with reference to content information of the corresponding recommendation content input from the recommendation content determination unit 113 for each piece of selected recommendation content for each slot. The card information is information including at least information used to receive the recommendation content and an effective period. The term “card” or “card information” is based on the fact that information of recommendation content is displayed as a card type image as an example and received according to an operation for the image in the reception device 20. The card information may include rankings for each service type with respect to each slot. The card creation/filing unit 121 determines rankings for each service type in descending order of scores of recommendation content. The card information will be described later.

The card creation/filing unit 121 arranges card information created for each piece of content according to the determined rankings and integrates the card information for each reception device 20 and each card acquisition unit time (e.g., 3 hours). The card creation/filing unit 121 stores the integrated card information in the card storage unit 122.

The card acquisition unit time is a period in which the reception device 20 acquired card information. The card acquisition unit time may be equal to or longer than the duration of the slot. When the card acquisition unit time is equal to the duration of the slot, the process of integrating card information for each card acquisition unit time may be omitted.

Card information created for each piece of content is integrated for each reception device 20 and each card acquisition unit time and stored in the card storage unit 122. Card information of each piece of content is arranged according to rankings determined for each service type with respect to each slot. The card storage unit 122 receives a card information request from the reception device 20 through the communication unit 131 for each card acquisition unit time. The card storage unit 122 transmits card information integrated with respect to the card acquisition unit time of that time to the reception device 20 through the communication unit 131 as a response to the card information request.

### (Selection of Recommendation Content)

Next, a method of selecting recommendation content by the card creation/filing unit 121 will be described using programs mainly as an example.

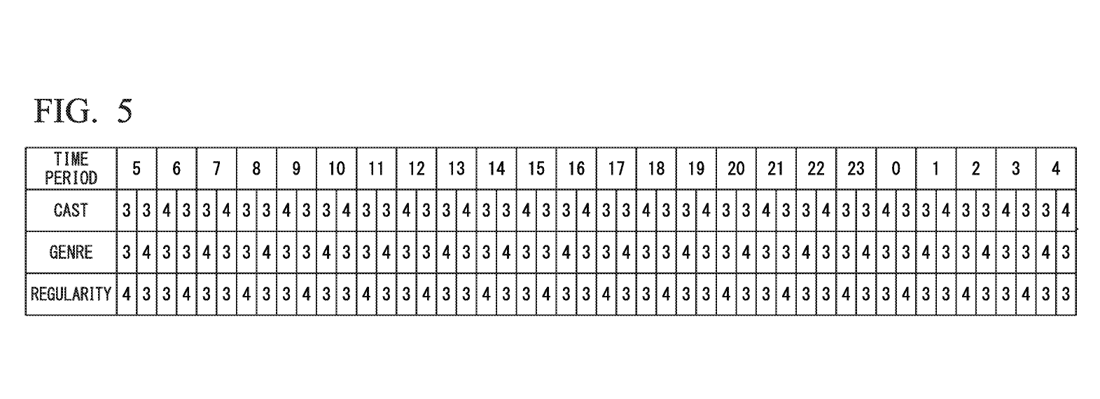

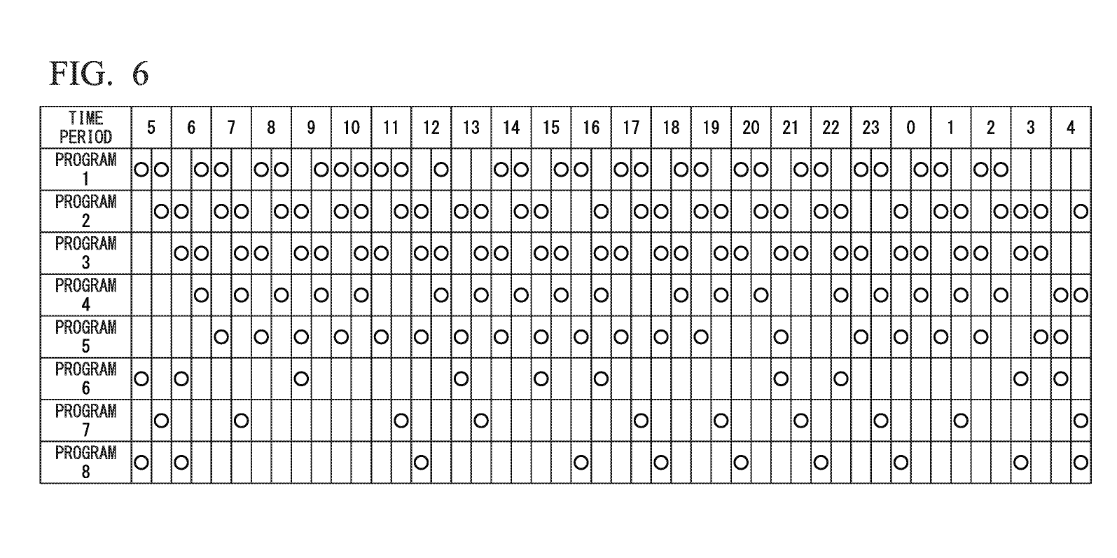

With respect to programs, recommendation content is determined for each of broadcast and reservation as service types. As illustrated in FIG. 5, an upper limit of the number of programs selected for each recommend type and each slot may be determined. A slot is a predetermined unit time with respect to selection. In the example illustrated in FIG. 5, the slot is a time period of 30 minutes starting every hour or every 30 minutes. The numerical values illustrated in FIG. 5 are upper limits of the number of pieces of content. For example, “3,” “3,” and “4” in the second column on the left of FIG. 5 indicate that upper limits of the numbers of programs selected using cast, genre and regularity as recommendation types in the slot from 05:00 to 05:30 are 3, 3 and 4, respectively.

The card creation/filing unit 121 regards a program of which all or part of a broadcast time is included in a slot as a candidate for recommendation content with respect to a broadcast of the corresponding slot and regards a program of which the broadcast time is included in a slot of a time after the corresponding slot as a candidate for recommendation content with respect to reservation of the corresponding slot. In addition, with respect to a program having a broadcast time extending over a plurality of slots, the card creation/filing unit 121 separately performs selection and ranking ordering of the program for each slot. For example, with respect to a program having a broadcast time from 19:00 to 20:54, the card creation/filing unit 121 identifies the program as a program having a broadcast time included in each of a slot of 19:00 to 19:30, a slot of 19:30 to 20:00, a slot of 20:00 to 20:30 and a slot of 20:30 to 21:00. However, the card creation/filing unit 121 identifies a program having a broadcast time which is included in a corresponding slot and continues until the following slot as recommendation content with respect to a broadcast of the corresponding slot instead of regarding the program as a candidate for recommendation content with respect to reservation.

Further, with respect to recommendation types for selection of programs received based on viewing histories, the card creation/filing unit 121 may increase an upper limit of the number of programs for a recommendation type having a higher selection frequency or reception frequency. When a case in which a program selected using a cast is received more frequently than programs selected using a genre and regularity is exemplified, the card creation/filing unit 121 may determine upper limits of the numbers of casts, genres and regularities as 6, 2 and 2. In addition, the card creation/filing unit 121 preferentially selects a number of programs set for each slot including recommendation types and broadcast times if the programs have higher scores indicated by recommendation content information.

In selection of programs, the card creation/filing unit 121 may allocate, to a slot in which broadcast times are included such that an appearance probability of a program increases as the score thereof increases, as many programs as the number set for the slot. The appearance probability may be a proportion of scores. In the example illustrated in FIG. 6, a case in which 8 programs 1 to 8 are selected as candidate content using casts and broadcast from the current day 05:00 to the next day 05:00 is exemplified. Here, it is assumed that scores of the programs 1, 2, 3, 4, 5, 6, 7 and 8 are 3, 3, 3, 2, 2, 1, 1 and 1, respectively. FIG. 6 shows that the programs 1, 2, 3, 4, 5, 6, 7 and 8 are allocated in each slot from the current day 05:00 to the next day 05:00 such that proportions of appearance probabilities thereof become 3, 3, 3, 2, 2, 1, 1 and 1. Symbol “∘” represents allocation of corresponding programs.

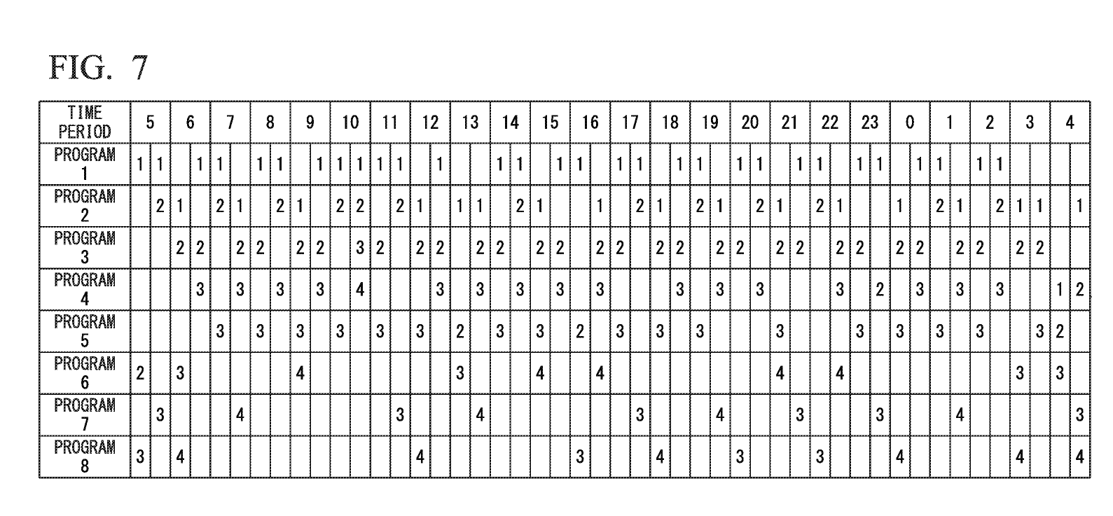

The card creation/filing unit 121 determines rankings of the allocated programs in descending order of the scores thereof for each slot. FIG. 7 illustrates an example of rankings determined for each of the allocated programs illustrated in FIG. 6. The card creation/filing unit 121 may arbitrarily determine a ranking for a plurality of programs having the same score value. For example, the card creation/filing unit 121 may increase a ranking when a time at which program information is processed is earlier. In addition, when programs selected between slots are the same, the card creation/filing unit 121 may randomly change rankings between slots. Accordingly, fixing of the same program to the same ranking is avoided. With respect to other recommendation types, the card creation/filing unit 121 also selects a number of programs set for each slot as recommendation content in the same manner. In addition, the card creation/filing unit 121 integrates programs selected for each slot for recommendation types and creates card information for each integrated program. The card creation/filing unit 121 handles recommendation content having a ranking the same as for recommendation types as recommendation content having the same ranking. However, there may be cases in which ranking ordering for recommendation content handled as the same ranking is required such as cases in which images representing respective pieces of recommendation content are displayed in the reception device 20. In such cases, the card creation/filing unit 121 may arbitrarily determine rankings of respective pieces of recommendation content handled as the same ranking. For example, predetermined rankings of recommendation types may be used as rankings of the respective pieces of recommendation content.

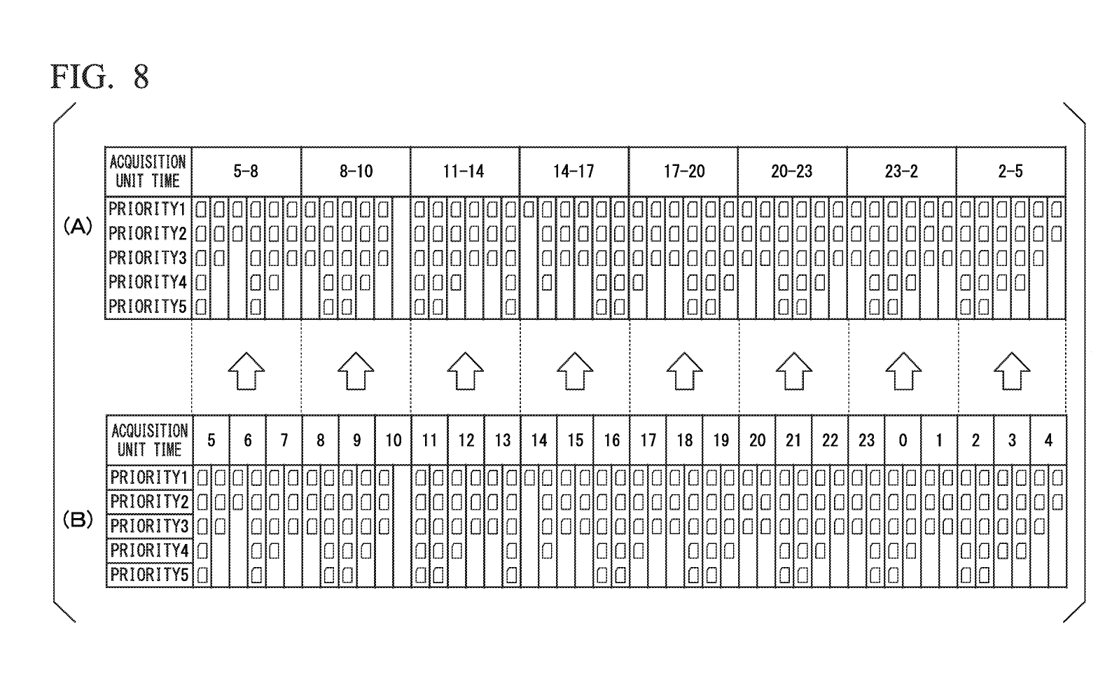

The card creation/filing unit 121 integrates card information created for each program for each card acquisition unit time and stores the integrated card information in the card storage unit 122. In the example illustrated in FIG. 8(A), card information created for each of 48 slots in 24 hours from the current day 05:00 to the next day 05:00 is integrated for card acquisition unit times temporally adjacent to each other. In FIG. 8, a rectangle represents each piece of card information. In the example illustrated in FIG. 8(B), a card acquisition unit time is 3 hours. An upper limit of the number of pieces of card information for each card acquisition unit time may be set for each service type. In the examples illustrated in FIG. 8, an upper limit of the number of pieces of card information about a broadcast for each card acquisition unit time is 30 and an upper limit of the number of pieces of recommendation content for each slot is 5. This is because integration of card information for each card acquisition unit time longer than a slot reduces the quantity of processing with respect to transmission/reception to/from the reception device 20. Information on rankings of card information in each slot is maintained even when the card information is integrated.

With respect to VOD content, the card creation/filing unit 121 may also select VOD content which becomes recommendation content using the same method as that for programs, and a unit time for selection of the selected VOD content may be longer than a slot used for programs. For example, the unit time may be 1 day. However, a service type of VOD content is one type which is VOD. The card creation/filing unit 121 may create card information about VOD content for each unit time and perform ranking ordering based on scores. When the unit time is longer than a slot used for programs, the card creation/filing unit 121 commonly applies card information and rankings created for each unit time for slots in the corresponding unit time.

Meanwhile, a predetermined time period for selecting recommendation content from candidate content selected on the ranking base may be set in the card creation/filing unit 121. This time period may be called a ranking base time period. Selection of recommendation content from candidate content selected on the ranking base may not be performed in periods other than the ranking base time period.

### (Card Information)

Next, an example of card information created by the card creation/filing unit 121 will be described.

The card creation/filing unit 121 creates card information for each piece of determined recommendation content based on content information of the recommendation content. The card creation/filing unit 121 determines a period in which a reception service for the recommendation content can be provided in the reception device 20 as an effective period as one element of card information for each piece of recommendation content. The effective period needs to be within a period in which at least recommendation content is transmitted or transmittable. A method of determining the effective period varies with service type.

With respect to a program having a service type which is broadcast, the card creation/filing unit 121 respectively determines an effective start time and an effective end time as a broadcast start time of the program and a time elapsed from the broadcast start time by a predetermined progress rate (e.g., 2/3) of a broadcast time. The effective start time and the effective end time are effective period start time and end time, respectively. Although it is desirable that the progress rate be greater than 0 and equal to or less than 1, it is typically equal to or greater than 1/2. The effective start time is determined as the broadcast start time in order to avoid channel selection for a program which is broadcast prior to the program before broadcast starts. The effective end time is determined as a time prior to the broadcast end time in order to avoid channel selection for a program which is broadcast after the program after broadcast ends and to prevent the user from having complaints about the fact that the user could not view the program earlier because the program is displayed just before the program ends.

With respect to a program having a service type which is reservation, the card creation/filing unit 121 does not particularly set an effective start time and determines an effective end time as a time a predetermined time (e.g., 1 hour) before a broadcast start time of the program. The effective end time is determined as a time before the broadcast start time of the program in order to avoid an operation of reservation in the reception device 20 after the program starts. In addition, immediately before the broadcast start time, the user usually obtains higher satisfaction when viewing a program broadcast at that time than reservation.

With respect to VOD content having a service type which is VOD, the card creation/filing unit 121 respectively determines an effective start time and an effective end time as a publication start time and a publication end time. An effective period is determined as a period from the publication start time to the publication end time in order to avoid an operation for reception performed by the user in the reception device 20 before or after publication. Publication refers to making content transmittable through the network NW.

Alternatively, the card creation/filing unit 121 may determine the effective period using other elements of VOD content information of the VOD content. For example, a period or a time period in which it is convenient for the user to view the content is set as the determined effective period.

More specifically, a time period from evening to night rather than morning may be set as a viewing time period for a movie that the user usually intends to view. In such a case, a table in which genres correspond to effective periods is set in the card creation/filing unit 121 in advance. A viewing time period corresponding to the genre of the movie is predetermined as an effective period. The card creation/filing unit 121 specifies an effective period corresponding to a genre included in the VOD content information with reference to the correspondence table. As will be described later, the VOD content is guided in a time period considered to be convenient for the user to view the VOD content, and thus the user is induced to view the VOD content in that time period. However, the effective period needs to be included between the publication start time and the publication end time of the VOD content. Accordingly, the card creation/filing unit 121 may determine an effective period obtained by excluding a part which is not included between the publication start time and the publication end time from the effective period obtained based on the correspondence table as an effective period of the VOD content.

The card creation/filing unit 121 creates card information including at least information individually identifying recommendation content, the effective period and information used for reception. With respect to a program, the information used for reception is a channel through which the program is broadcast. With respect to VOD content, the information used for reception is acquisition destination information such as a URL of a server device which is able to transmit the VOD content.

Further, when the card creation/filing unit 121 has created card information about recommendation content having a slot which is not in an effective period among card information stored in the card storage unit 122, the card creation/filing unit 121 eliminates that card information.

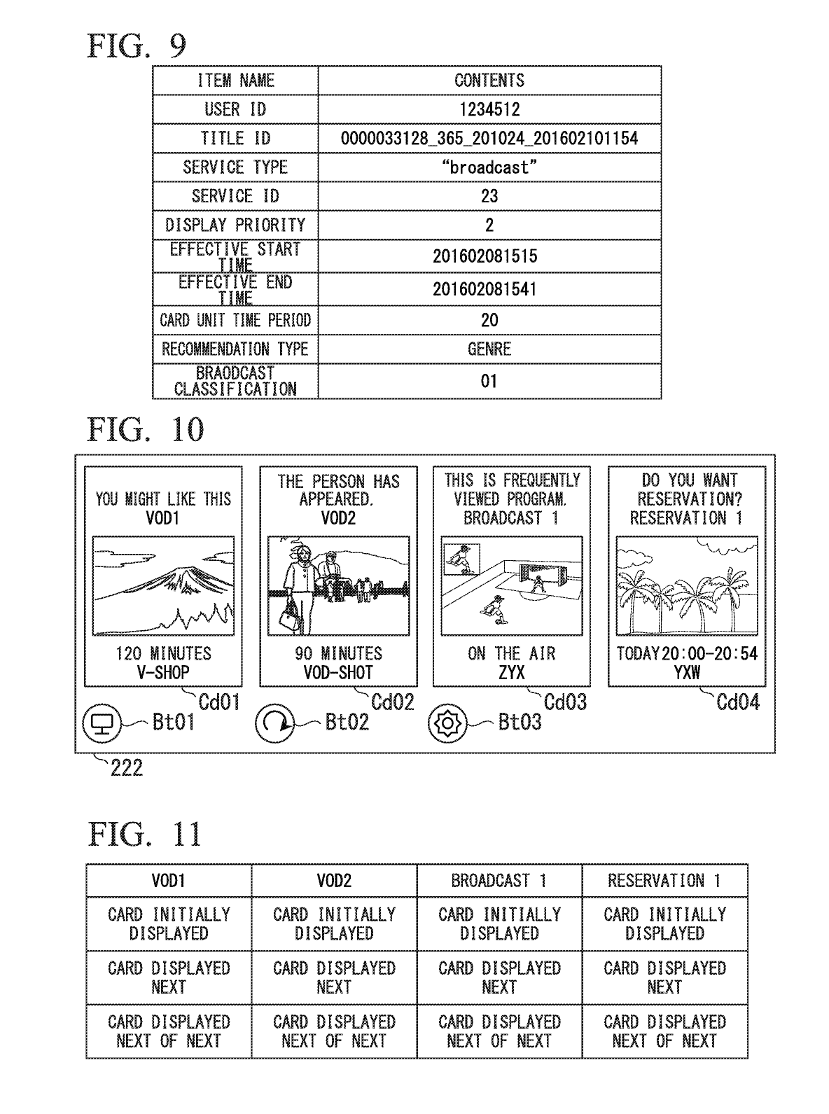

FIG. 9 is a diagram illustrating an example of card information. The card information illustrated in FIG. 9 includes a user ID, a title ID, a service type, a service ID, display priority, an effective start time, an effective end time, a card display time period, a recommendation type and broadcast classifications. The user ID is identification information of the user of the reception device 20 which is a transmission destination. The title ID is identification information of a program. The title ID is information corresponding to a program ID or a content ID. The service type “broadcast” represents that the service type is “broadcast.”

The service ID is a number of a channel through which a program is broadcast. The display priority is a numerical value indicating a ranking set for each slot. A smaller numerical value represents a higher ranking. The card display time period “20” is a value indicating 20:00 as a start time of a card acquisition unit time. Broadcast classification “01” refers to a terrestrial station among types of broadcast station, that is, the terrestrial station, a broadcasting satellite (BS) station, a communication satellite (CS) station and others. Further, the card information may include slot identification information instead of or along with the card display time period.

In addition, the card information may include a content title and other messages.

### (Configuration of Reception Device)

The configuration of the reception device 20 according to the present embodiment will be described referring back to FIG. 1.

The reception device 20 includes a card acquisition unit 201, a card display function/activation unit 202, a channel selection function unit 211, a reservation function unit 212, a VOD function unit 213, a person detection unit 221, a display unit 222, an input unit 223, a communication unit 231 and a broadcast reception unit 232.

The card acquisition unit 201 transmits a card information request to the infonnation provision device 10 through the communication unit 231 for each card acquisition unit time. The card acquisition unit 201 receives card information of the card acquisition unit time from the information provision device 10 as a response to the card information request and stores the received card information.

The card display function/activation unit 202 controls display of an image of a card representing recommendation content relating to card information on the display unit 222 and a process relating to a recommendation content reception service according to an instruction for the displayed card. The card display function/activation unit 202 starts the process when activation is instructed. Instruction of activation means input of a detection signal from the person detection unit 221 or an operation signal representing activation is input from the input unit 223.

The card display function/activation unit 202 includes a card display control unit 203 and a function control unit 204.

The card display control unit 203 reads card information of a slot which is a time period including the time of the corresponding point in time (current time) from the card acquisition unit 201. When the slot including the current time is updated according to the lapse of time, the card display control unit 203 eliminates card information of the slot before being updated.

The card display control unit 203 determines whether the current time is within an effective period included in the card information. With respect to recommendation content determined to be within an effective period, the card display control unit 203 creates image data representing information of the recommendation content with respect to the read card information. The created image data includes an image having the form of a card as an example.

For example, the information of the recommendation content includes information by which the user is able to identify an individual piece of recommendation content by sight, such as a title, a broadcast time or a play time, and a broadcast station name or a content provider name. The card display control unit 203 outputs a predetermined number of pieces of created image data to the display unit 222 for each service type of recommendation content. The display unit 222 displays an image representing information of a predetermined number of pieces of recommendation content for each service type. The card display control unit 203 switches image data representing information of recommendation content which is an output target according to the ranking of the recommendation content whenever an operation signal representing switching is input from the input unit 223.

With respect to recommendation content determined to be out of the effective period, the card display control unit 203 does not output image data. When image data has already been output to the display unit 222 with respect to the recommendation content, the card display control unit 203 stops the output. Accordingly, an image representing information of the recommendation content which is displayed on the display unit 222 is eliminated. The card display control unit 203 may output image data representing information of recommendation content having a ranking next to the recommendation content to the display unit 222.

The function control unit 204 causes a function unit corresponding to a service type of recommendation content with respect to a pressed image to execute a process for performing a function with respect to the service type. Pressing means indicating an image input from the input unit 223 or the position of the image in a display area through an operation signal in addition to real pressing.

With respect to broadcast as a service type, for example, the function control unit 204 outputs card information of a program with respect to a pressed image and an activation instruction to the channel selection function unit 211. The card information includes information of a channel as reception information used for reception of the program. Accordingly, the channel selection function unit 211 starts execution of a channel selection process (which will be described later).

With respect to reservation as a service type, the function control unit 204 outputs card information of a program with respect to a pressed image and an activation instruction to the reservation function unit 212. The card information includes information of a channel and a broadcast time as reception information used for reception of the program. Accordingly, the reservation function unit 212 starts execution of a reservation process (which will be described later).

With respect to VOD as a service type, the function control unit 204 outputs card information of VOD content with respect to a pressed image and an activation instruction to the VOD function unit 213. The card information includes acquisition destination information such as a URL as reception information used for reception of the VOD content. The VOD function unit 213 starts execution of a VOD reception process (which will be described later) when the activation instruction is input from the function control unit 204.

The channel selection function unit 211 executes the channel selection process when the activation instruction is input from the function control unit 204. More specifically, the channel selection function unit 211 identifies a channel from the card information input from the function control unit 204. The channel selection function unit 211 causes the broadcast reception unit 232 to receive a broadcast signal of a frequency band corresponding to the identified channel. The channel selection function unit 211 separates video data from the broadcast signal received by the broadcast reception unit 232 and outputs the separated video data to the display unit 222.

The reservation function unit 212 executes the reservation process when the activation instruction is input from the function control unit 204. More specifically, the reservation function unit 212 identifies a channel, a broadcast start time and a broadcast end time from the card information input from the function control unit 204. The reservation function unit 212 causes the broadcast reception unit 232 to start reception of a broadcast signal of a frequency band corresponding to the identified channel when the current time reaches the broadcast start time. The reservation function unit 212 separates video data from the broadcast signal received by the broadcast reception unit 232 and stores the separated video data. The reservation function unit 212 causes the broadcast reception unit 232 to finish reception of the broadcast signal when the current time reaches the broadcast end time. The reservation function unit 212 stops storage of video data according to finishing of reception. The reservation function unit 212 outputs stored video data to the display unit 222 when an operation signal instructing playback is input from the input unit 223. Accordingly, images of the stored program are displayed.

Meanwhile, the channel selection function unit 211 and the reservation function unit 212 create channel selection information including a reception start time and a reception end time as a viewing start time and a viewing end time. Further, the channel selection function unit 211 and the reservation function unit 212 include user IDs set therein, areas in which they are installed, and channel numbers of channels with respect to reception as a part of the channel selection information. The channel selection function unit 211 and the reservation function unit 212 transmit created channel selection information to the information provision device 10 and the external server 30 through the communication unit 231.

The VOD function unit 213 executes the VOD reception process when the activation instruction is input from the function control unit 204. More specifically, the VOD function unit 213 identifies acquisition destination information from the card information input from the function control unit 204. The VOD function unit 213 transmits a VOD content request to the external server 30 indicated by the identified acquisition destination information through the communication unit 231.

The VOD function unit 213 receives VOD content data designated by the acquisition destination information from the external server 30 as a response to the VOD content request. The VOD function unit 213 outputs video data included in the received VOD content data to the display unit 222.

Meanwhile, the VOD function unit 213 creates VOD selection information including a reception start time and a reception end time as a viewing start time and a viewing end time. Further, the VOD function unit 213 includes a user ID set therein and a content ID received in addition to the VOD content data as a part of the VOD selection information. The VOD function unit 213 transmits the created VOD selection information to the information provision device 10 and the external server 30 through the communication unit 231.

The person detection unit 221 is provided on the surface of the housing of the reception device 20 and detects a person located within a predetermined range (e.g., 1 m) therefrom. For example, the person detection unit 221 includes a human detection sensor. The person detection unit 221 creates a detection signal representing detection when detecting a person. The person detection unit 221 outputs the created detection signal to the card display function/activation unit 202.

The display unit 222 displays an image based on image data input from the card display control unit 203. In addition, the display unit 222 displays video based on video data input from the channel selection function unit 211 and the VOD function unit 213. For example, the display unit 222 includes a liquid crystal display, an organic electro-luminescence (EL) display or the like.

The input unit 223 acquires an operation signal created according to an operation of the user and outputs the acquired operation signal to the card display function/activation unit 202. For example, the input unit 223 may include an infrared interface which receives an operation signal from a control device (a remote controller which will be called a remote control hereinafter), a dedicated member such as a button which creates an operation signal according to an operation of a user, and a general member such as a touch sensor. Contents of indication by an operation are distinguished according to an operated button or an indicated position.

The communication unit 231 transmits/receives various types of data to/from apparatuses connected to the network NW. For example, the communication unit 231 is a communication interface.

The broadcast reception unit 232 receives broadcast signals transmitted from broadcast equipment of broadcasters through a frequency band according to a channel indicated by the channel selection function unit 211 or the reservation function unit 212.

For example, the broadcast reception unit 232 is a tuner.

### (Display Example)

Next, an example of displaying an image representing information of recommendation content will be described.

FIG. 10 is a diagram illustrating an example of displaying images representing information on recommendation content.

Four card type images Cd01 to Cd04 and three buttons Bt01 to Bt03 are displayed in a display area of the display unit 222 as images representing information on recommendation content.

The images Cd01 to Cd04 are arranged from left to right at the middle of the display area.

The images Cd01 and Cd02 represent information on VOD content. The images Cd01 and Cd02 respectively represent messages, titles, screen shots, display times and provider names from the upper side to the lower side. A screen shot is an image representing one scene included in the corresponding image. Cd03 and Cd04 are images representing information on programs. When the image Cd01 or Cd02 is pressed, the function control unit 204 causes the VOD function unit 213 to execute the VOD reception process with respect to the VOD content relating to the pressed image.

The images Cd03 and Cd04 respectively represent messages, titles, screen shots, service provision states and broadcast station names from the upper side to the lower side. The service type of the program relating to the image Cd03 is broadcast. The character string “on the air” included in the image Cd03 indicates that the corresponding program is being broadcast at that time. When the image Cd03 is indicated, the function control unit 204 causes the channel selection function unit 211 to execute the change selection process with respect to the program relating to the indicated image. The service type of the program relating to the image Cd04 is reservation. The character string “Today 20:00-20:54” included in the image Cd04 indicates that the scheduled broadcast time is 20:00 to 20:54 today. When the image Cd04 is indicated, the function control unit 204 causes the reservation function unit 212 to execute the reservation process with respect to the program relating to the indicated image.

The buttons Bt01, Bt02 and Bt03 are arranged in this order from the left side to the right side in a predetermined range from the lower left side of the display area of the display unit 222. The button Bt01 is a button for instructing suspension and activation of a function of the reception device 20 for each instruction. The button Bt02 is a button for instructing display of an image representing information on content having the next display ranking according to instruction. An operation signal representing switching is input to the card display control unit 203 according to an instruction applied to the button t02. The button Bt03 is a button for displaying a menu screen according to instruction. The menu screen includes various setting screens, usage method guiding screens and the like, for example.

Detection of pressing may be performed through an operation signal from a touch sensor (not shown) provided on the front face or the rear face of the display area of the display unit 222 or an operation signal from a remote control (not shown). As an example, a remote control having a cursor movement button group and a selection button may be used. The cursor movement button group includes four buttons for creating operation signals instructing cursor movements in vertical and horizontal directions according to pressing. The function control unit 204 causes the display unit 222 to display a cursor indicating a position on the display area indicated at the corresponding time and moves the cursor in a direction indicated by an operation signal input from the remote control through the input unit 223. The selection button is a button for creating an operation signal indicating a position at which a cursor is represented by being pressed. The function control unit 204 performs a process relating to an image displayed at a position indicated by an input operation signal. Meanwhile, the remote control may include one button corresponding to each of the images Cd01 to Cd04. A button may have the same color as a background color of an image corresponding thereto. The remote control generates an operation signal representing an image corresponding to a button according to pressing of the button. Accordingly, the user is able to easily select recommendation content represented by an image as content that the user intends to receive by pressing a button having the same color as the background color of the image.

### (Display Rank)

The card display control unit 203 outputs image data representing information on recommendation content having a display rank next to recommendation content displayed at the corresponding time to the display unit 222 as recommendation content which is an output target whenever an operation signal indicating switching is input from the input unit 223.

FIG. 11 is a diagram illustrating an example of display ranks. In the example illustrated in FIG. 11, there are two images representing information on VOD content, one image representing a program having a service type corresponding to broadcast, and one image representing a program having a service type corresponding to reservation. VOD1, VOD2, broadcast 1 and reservation 1 are signs identifying the respective images and correspond to the images Cd01, Cd02, Cd03 and Cd04 shown in FIG. 10. Each row represents display ranks. A higher row represents a higher display rank and a lower row represents a lower display rank.

The card display control unit 203 determines VOD content assigned every third ranks from the first rank as recommendation content displaying information as VOD1 and determines display ranks thereof in the order of descending ranks. The card display control unit 203 determines VOD content assigned every third ranks from the second rank as recommendation content displaying information as VOD2 and determines display ranks thereof in the order of descending ranks. For example, VOD content assigned second, fourth and sixth ranks is determined as recommendation content displaying information as cards firstly (initially), secondly and thirdly as VOD2, respectively. Programs having service types of broadcast and reservation are respectively determined as recommendation content displaying information as broadcast 1 and reservation 1, and ranks assigned thereto are determined as display ranks as they are.

Further, when the display rank of recommendation content displayed at the corresponding time is a lowest rank, the card display control unit 203 outputs image data representing information on content having a highest display rank to the display unit 222 when the operation signal indicating switching is input.

There may be cases in which recommendation content for which the current time is not within an effective period may be generated according to the lapse of time. In such cases, the card display control unit 203 excludes recommendation content which is not within an effective period from recommendation content corresponding to output targets of image data. The card display control unit 203 determines display ranks of remaining recommendation content having the same service type as the service type of the excluded recommendation content among recommendation content with respect to a slot of the current time.

### (Information Provision Procedure)

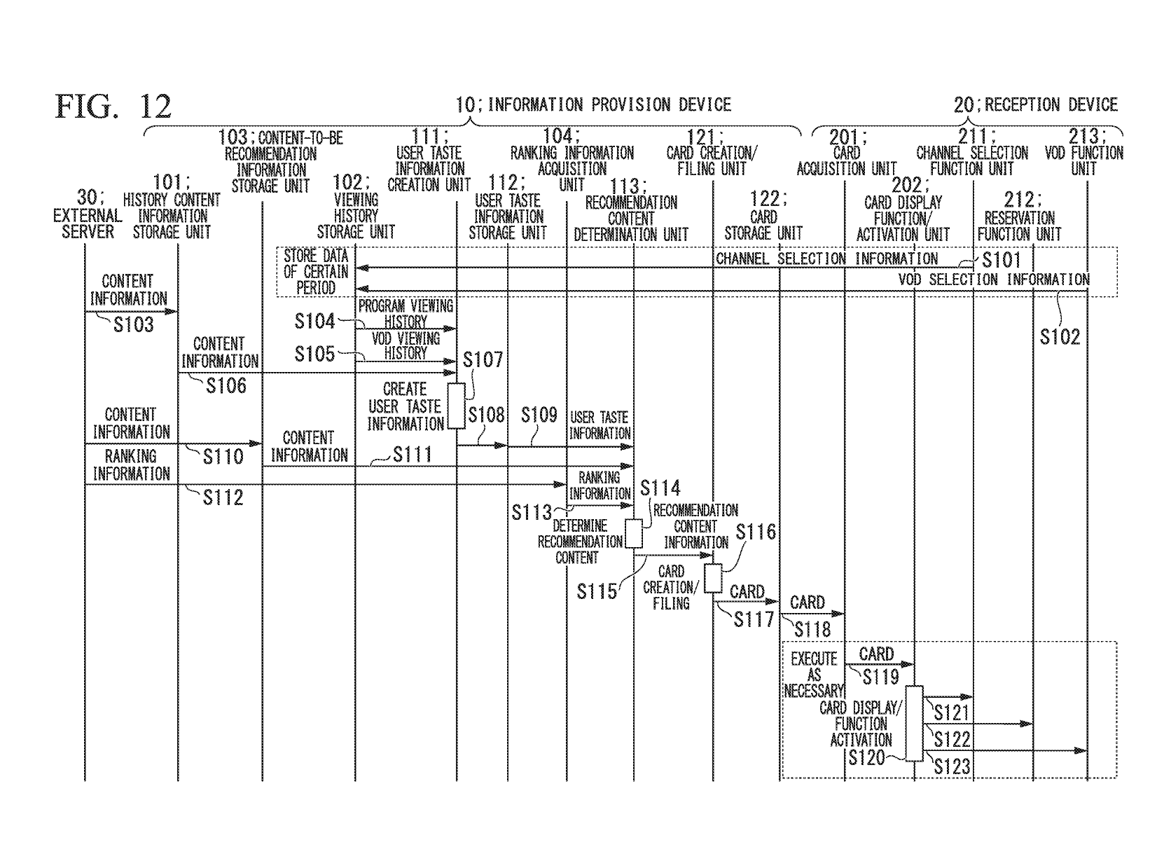

Next, an information provision procedure according to the present embodiment will be described. FIG. 12 is a sequence diagram illustrating an example of the information provision procedure according to the present embodiment. The procedure illustrated in FIG. 12 includes processes of steps S101 to S123. The processes of steps S101 and S102 are performed as necessary according to execution of the processes of steps S121 to S123.

(Step S101) The channel selection function unit 211 or the reservation function unit 212 of the reception device 20 creates channel selection information representing a viewing time of a program and transmits the created channel selection information to the information provision device 10 according to reception of the program.

(Step S102) The VOD function unit 213 of the reception device 20 creates VOD selection information representing a viewing time of VOD content and transmits the created VOD selection information to the information provision device 10 according to reception of the VOD content. The viewing history storage unit 102 of the information provision device 10 stores channel selection information and VOD selection information received from each reception device 20 for a certain period of time for each reception device 20 to form a program viewing history and a VOD viewing history.

(Step S103) The external server 30 transmits program information about programs which have been broadcast and VOD content information about VOD content which has been transmitted to the information provision device 10 as content information. The history content information storage unit 101 of the information provision device 10 stores the content information received from the external server 30. Then, the procedure proceeds to the process of step S104.

(Step S104) The user taste information creation unit 111 acquires the program viewing history formed in the viewing history storage unit 102. Then, the procedure proceeds to the process of step S105.

(Step S105) The user taste information creation unit 111 acquires the VOD viewing history formed in the viewing history storage unit 102. Then, the procedure proceeds to the process of step S106.

(Step S106) The user taste information creation unit 111 acquires program information on each program indicated by the program viewing history and VOD content information on each piece of VOD content indicated by the VOD viewing history from the history content information storage unit 101 as content information. Then, the procedure proceeds to the process of step S107.

(Step S107) The user taste information creation unit 111 creates user taste information representing attributes belonging to the taste of the user with reference to the acquired program information and VOD content information. Then, the procedure proceeds to the process of step S108.

(Step S108) The user taste information creation unit 111 stores user taste information created for each reception device 20 in the user taste information storage unit 112. Then, the procedure proceeds to the process of step S109.

(Step S109) The recommendation content determination unit 113 reads the user taste information for each reception device from the user taste information storage unit 112. Then, the procedure proceeds to the process of step S110.

(Step S110) The external server 30 transmits program information about programs scheduled to be broadcast and VOD content information about transmittable VOD content to the information provision device 10 as content information. The content-to-be-recommended information storage unit 103 of the information provision device 10 stores the content information received from the external server 30. Then, the procedure proceeds to the process of step S111.

(Step S111) The recommendation content determination unit 113 reads program information and VOD content information from the content-to-be-recommended infonnation storage unit 103 as content information. Then, the procedure proceeds to the process of step S112.

(Step S112) The external server 30 transmits ranking information created for each unit time to the information provision device 10. The ranking information acquisition unit 104 of the information provision device 10 acquires the ranking information from the external server 30. Then, the procedure proceeds to the process of step S113.

(Step S113) The ranking information acquisition unit 104 outputs the acquired ranking information to the recommendation content determination unit 113. Then, the procedure proceeds to the process of step S114.

(Step S114) The recommendation content determination unit 113 determines programs and VOD content having a taste element as candidate content for each recommendation type based on the user taste information from content relating to the acquired content information (viewing trend base). The recommendation content determination unit 113 assigns a higher score to content having a larger number of the elements.

The recommendation content determination unit 113 determines programs and VOD content relating to ranking information as candidate content from content relating to the acquired content information (ranking base). The recommendation content determination unit 113 assigns a higher score to content having a higher rank indicated by the ranking information. Then, the procedure proceeds to the process of step S115.

(Step S115) The recommendation content determination unit 113 outputs recommendation content information representing a score for each piece of candidate content to the card creation/filing unit 121 with respect to the candidate content determined on the viewing trend base and the candidate content determined on the ranking base. Then, the procedure proceeds to the process of step S116.

(Step S116) The card creation/filing unit 121 determines a higher rank for a higher score with respect to each service type for each slot and preferentially selects a predetermined number of pieces of recommendation content having higher ranks from the candidate content indicated by the recommendation content information input from the recommendation content determination unit 113. The card creation/filing unit 121 determines an effective period based on a period in which transmission is performed or transmission may be performed indicated by content information on each piece of recommendation content. Here, the card creation/filing unit 121 determines an effective period according to the service type of the recommendation content reception service. The card creation/filing unit 121 creates card information including a rank for each service type, reception information used for reception and the effective period for each piece of recommendation content. The card creation/filing unit 121 integrates the card infonnation created for each piece of recommendation content with respect to each reception device 20 for each card acquisition unit time composed of one or more slots and stores the integrated card information in the card storage unit 122. Then, the procedure proceeds to the process of step S117.

(Step S117) The card storage unit 122 transmits card information integrated with respect to the reception device 20 according to reception of a card information request from the reception device 20 for each card acquisition unit time. Then, the procedure proceeds to the process of step S118.

(Step S118) The card acquisition unit 201 of the reception device 20 receives card information according to transmission of a card information request to the information provision device 10 for each card acquisition unit time and stores the received card information. Then, the procedure proceeds to the process of step S119.

(Step S119) The card display function/activation unit 202 activates according to detection of a person or an activation instruction and executes the processes of the present step to step S123 as necessary. The card display function/activation unit 202 reads card information of a slot including the current time from the card acquisition unit 201.

(Step S120) The card display function/activation unit 202 determines whether the current time is within the effective period included in the card information. With respect to recommendation content for which the current time has been determined to be within the effective period, the card display function/activation unit 202 creates image data representing information on recommendation content relating to the read card information for each piece of recommendation content. The card display function/activation unit 202 determines a higher display rank for a service type assigned a higher rank and outputs image data representing information on recommendation content having a high display rank to the display unit 222. The card display function/activation unit 202 outputs image data representing information on recommendation content having the next high display rank to the display unit 222 for each switching instruction. With respect to recommendation content for which the current time has been determined to be out of the effective period, the card display function/activation unit 202 does not output image data representing information on the recommendation content to the display unit 222. With respect to recommendation content for which the current time has been determined to be out of the effective period among recommendation content for which image data corresponding thereto has already been output, the card display function/activation unit 202 stops output of the image data. The card display function/activation unit 202 resets the display order with respect to recommendation content remaining after the recommendation content is excluded for the service type of the recommendation content.

(Step S121) When content relating to an image indicated according to an operation is a program and the service type is broadcast, the card display function/activation unit 202 outputs card information of the program and an activation instruction to the channel selection function unit 211. The channel selection function unit 211 executes the channel selection process.

(Step S122) When content relating to an image indicated according to an operation is a program and the service type is reservation, the card display function/activation unit 202 outputs card information of the program and an activation instruction to the reservation function unit 212. The reservation function unit 212 executes the reservation process.

(Step S123) When content relating to an image indicated according to an operation is VOD content (the service type is VOD), the card display function/activation unit 202 outputs card information of the VOD content and an activation instruction to the VOD function unit 213. The VOD function unit 213 executes the VOD reception process.

As described above, the information provision device 10 according to the present embodiment includes the recommendation content determination unit 113 as a determination unit which determines candidate content which are candidates for recommendation content from content scheduled to be transmitted based on a viewing history of content received from the reception device 20. In addition, the information provision device 10 includes the card creation/filing unit 121 as a creation unit which transmits card information to the reception device 20 as an example of recommended content information. The card creation/filing unit 121 selects a predetermined number of pieces of recommendation content from the candidate content, determines an effective period according to the service type of the recommendation content reception service and transmits card information created including the effective period to the reception device 20.

In addition, the reception device 20 according to the present embodiment includes the channel selection function unit 211, the reservation function unit 212 and the VOD function unit 213 as function units which receive content and includes the card acquisition unit 201 which acquires card information including an effective period of recommendation content. Further, the reception device 20 includes the card display function/activation unit 202 as a control unit which controls whether to output an image representing recommendation content according to whether the current time is within the effective period and causes an aforementioned function unit to receive recommendation content according to instruction for the image.

According to this configuration, recommendation content suitable for a viewing tendency of a user is selected based on a viewing history of viewed content and the reception device 20 is notified of card information including an effective period according to the service type of the reception service for the recommendation content. In the reception device 20, an image representing the selected recommendation content is displayed when the current time is within the effective period and the recommendation content reception service is provided according to an instruction for the image. When the current time is not within the effective period, an image representing the selected recommendation content is not displayed and thus reception of the recommendation content according to an instruction for the image can be avoided. Accordingly, it is possible to reliably receive the recommendation content. In addition, the image is not displayed and thus the user may be prevented from unnecessarily expecting the recommendation content.

The recommendation content determination unit 113 selects content having an attribute the same as for content received through the reception device 20 as candidate content and determines scores of the candidate content according to the quantity of reception of received content having the attribute. In addition, the card creation/filing unit 121 selects a predetermined number of pieces of recommendation content for each unit time based on scores determined from previous candidate content.

According to this configuration, a predetermined number of pieces of recommendation content are selected according to a degree of the attribute from candidate content having a common attribute for viewed content for each unit time. Accordingly, the user is able to obtain information on recommendation content which can be received at the current time and is suitable for the taste of the user.

### Second Embodiment

Next, a second embodiment of the present invention will be described. Components the same as those in the first embodiment are denoted by the same reference signs and description thereof will be cited, and differences from the first embodiment will be mainly described.

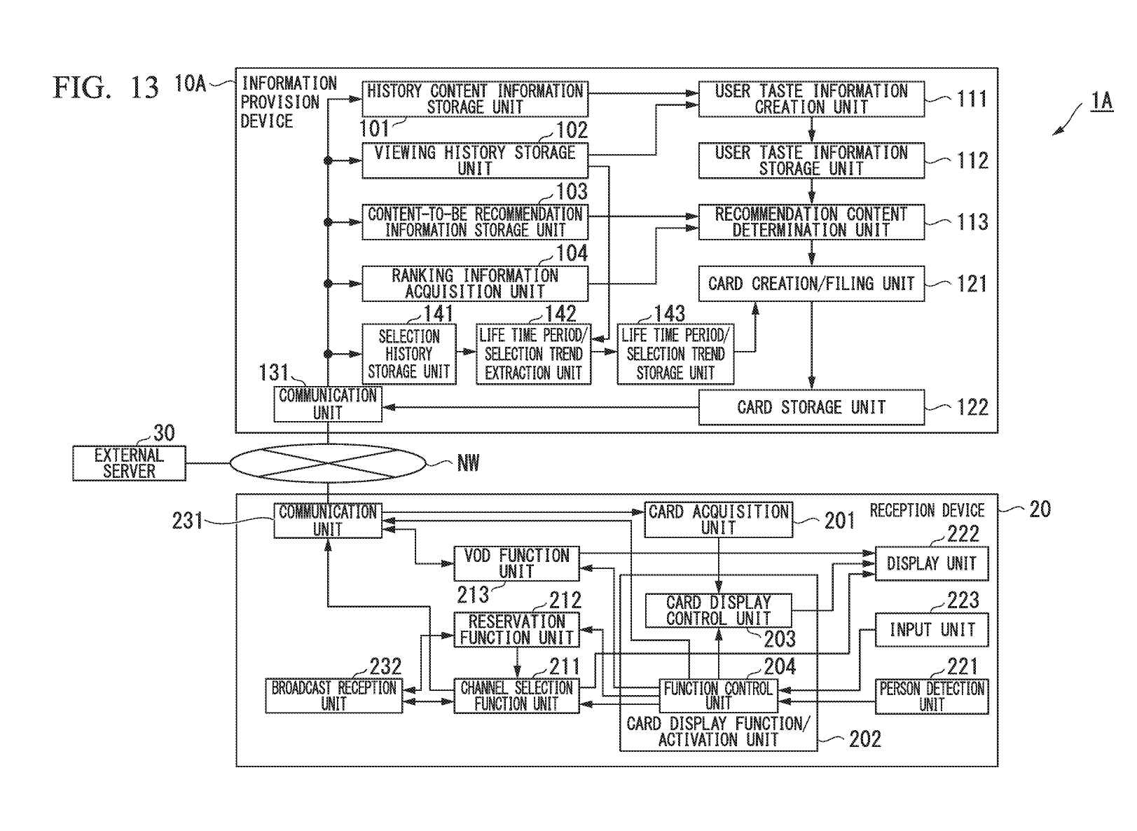

FIG. 13 is a schematic block diagram illustrating an example of an information provision system 1A according to the present embodiment. The information provision system 1A includes an information provision device 10A, a reception device 20 and the external server 30.

The information provision device 10A includes the history content information storage unit 101, the viewing history storage unit 102, the content-to-be-recommended information storage unit 103, the ranking information acquisition unit 104, the user taste information creation unit 111, the user taste information storage unit 112, the recommendation content determination unit 113, the card creation/filing unit 121, the card storage unit 122, the communication unit 131, a selection history storage unit 141, a life time period/selection trend extraction unit 142 and a life time period/selection trend storage unit 143.

In the information provision device 10A according to the present embodiment, the card creation/filing unit 121 creates card information further including information on a recommendation type used for selection of recommendation content, as described above. The function control unit 204 of the reception device 20 extracts information on a recommendation type from card information on content selected according to an instruction for an image displayed on the display unit 222. The function control unit 204 creates card selection information including the time at which the content has been selected, the extracted information on the recommendation type and identification information of the recommendation content. The function control unit 204 transmits the created card selection information to the information provision device 10A through the communication unit 231.

The channel selection function unit 211 and the reservation function unit 212 of the reception device 20 create channel selection information further including broadcast classification extracted from card information on a selected program as a part thereof and transmit the created channel selection information to the information provision device 10.

In addition, the reception device 20 may include an input content function unit (not shown) which receives content data of other different types when an operation signal instructing playback is input in addition to VOD content and outputs video data representing an image of that content to the display unit 222. For example, content data of other types may include content data input from an external input terminal, content data stored in a storage medium such as an attached USB memory, and the like. The input content function unit creates input content selection information including a user ID, a content ID identifying content instructed to be played, a viewing start time and a viewing end time. The input content function unit transmits the created input content function unit to the information provision device 10A through the communication unit 231. The viewing history storage unit 102 of the information provision device 10A may sequentially store input content selection information received from the reception device 20 through the communication unit 131 to form an input content viewing history.

The selection history storage unit 141 of the information provision device 10 stores card selection information received through the communication unit 131 for each reception device 20 to form a selection history.

The life time period/selection trend extraction unit 142 reads a selection history in a predetermined period (e.g., for 90 days before the corresponding time) for each reception device 20 from the selection history storage unit 141 and analyzes the quantity of reception for each recommendation type with respect to each time period based on the read selection history to create selection trend information. More specifically, the life time period/selection trend extraction unit 142 counts the number of selections of recommendation content for each recommendation type (i.e., the number of indications of a card type image in the reception device 20) with respect to each slot of each day as the number of selections with reference to the read selection history. The life time period/selection trend extraction unit 142 may perform counting of the number of selections for each set of a day, a slot and a service type. The life time period/selection trend extraction unit 142 creates selection trend information representing the counted number of selections and stores the created selection trend information in the life time period/selection trend storage unit 143.

In addition, the life time period/selection trend extraction unit 142 reads a program viewing history and a VOD viewing history from the viewing history storage unit 102 as a viewing history in a predetermined period (e.g., for 90 days before the corresponding time) for each reception device 20. The life time period/selection trend extraction unit 142 analyzes the quantity of reception for each time period based on the read viewing history to create life time period information. More specifically, the life time period/selection trend extraction unit 142 determines whether each slot of each day is a viewing time period in which the proportion of a viewing time of a program is greater than a predetermined proportion (e.g., 0.5, 15 minutes when the slot length is 30 minutes) with reference to the program viewing history. The life time period/selection trend extraction unit 142 may perform determination of a viewing time period for each broadcast classification. Here, the life time period/selection trend extraction unit 142 extracts broadcast classifications from channel selection information of individual programs constituting the viewing history.

The life time period/selection trend extraction unit 142 determines whether each slot of each day is a viewing time period in which the proportion of a viewing time of VOD content is greater than a predetermined proportion with reference to the VOD viewing history. The life time period/selection trend extraction unit 142 may add a viewing time of input content for each slot of each day to the viewing time of the VOD content to calculate a viewing time of content of service types other than broadcast further with reference to an input viewing history in a predetermined period read for each reception device 20. The life time period/selection trend extraction unit 142 determines a viewing time period in which the proportion of a viewing time of content other than broadcast is greater than a predetermined proportion. The life time period/selection trend extraction unit 142 creates life time period information including flag information representing whether the corresponding viewing time period is a viewing time period for each service type and stores the created life time period information in the life time period/selection trend storage unit 143. The life time period/selection trend extraction unit 142 may handle broadcast classifications as a kind of service type.

The life time period/selection trend storage unit 143 stores the life time period information and selection trend information created by the life time period/selection trend extraction unit 142 for each reception device 20.

In the present embodiment, the card creation/filing unit 121 determines an upper limit of the number of pieces of card information of each slot of each day based on one or both of the life time period information and the selection trend information created for each reception device 20. More specifically, with respect to a slot (broadcast recommendation positive slot) having a different determination of whether the slot is a viewing time period from temporally adjacent slots for broadcast, the card creation/filing unit 121 determines an upper limit of the number of pieces of card information about broadcast as a service type, that is, the number of pieces of recommendation content as a larger number than that for other slots with reference to the life time period information. The card creation/filing unit 121 selects programs corresponding to a number (i.e., the aforementioned upper limit of the number) determined in descending order of scores as recommendation content from programs having a service type of broadcast among candidate content of that slot. The slot having a different determination of whether the slot is a viewing time period from temporally adjacent slots is a slot in which a temporal variation in the quantity of reception is greater than a predetermined temporal variation. In other words, such a slot is a time period which may include a viewing start time or a viewing end time at which whether viewing will be performed is determined in user's life. Many programs are recommended in such a time period, a possibility that programs suitable for the user's taste are viewed without omission may increase.

With respect to a slot (VOD recommendation slot) determined to be a viewing time period of content other than broadcast, the card creation/filing unit 121 determines an upper limit of the number of pieces of card information about VOD as a service type as a larger number than that for other slots. The card creation/filing unit 121 selects VOD content corresponding to a number (i.e., the aforementioned upper limit) determined in descending order of scores as recommendation content from VOD content (having a service type of VOD) which is candidate content of that slot. Such a slot is a time period in which content including VOD content other than programs is viewed in user's life. A lot of VOD content is recommended in such a time period, a possibility that VOD content suitable for the user's taste is viewed without omission may increase. In addition, a user who is viewing content other than VOD content may be induced to view VOD content.

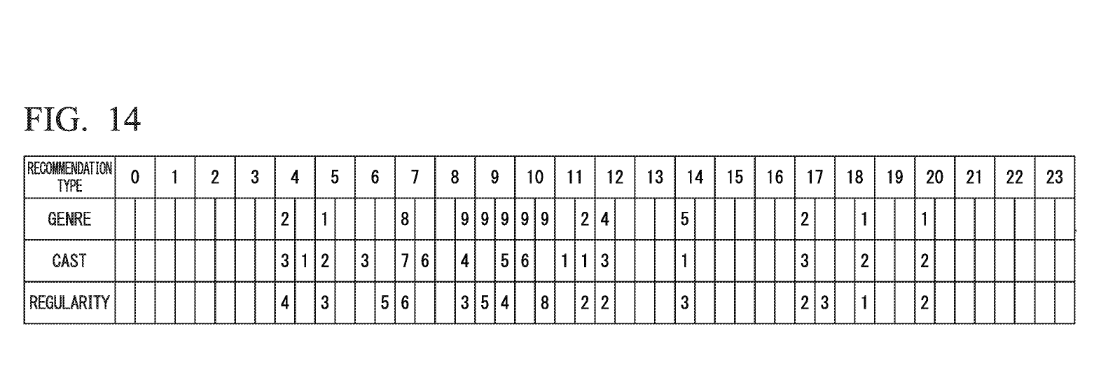

The card creation/filing unit 121 determines an upper limit of the number of pieces of card information, that is, the number of pieces of recommendation content, such that the upper limit increases for a recommendation type having a larger number of selections for each slot of each day with reference to the selection trend information. Accordingly, candidate content selected through a recommendation type used to select content frequently received in the reception device 20 is selected as recommendation content many times. As an example, the card creation/filing unit 121 determines the upper limit of the number of pieces of card information for each recommendation type by proportionally dividing the upper limit of the number of pieces of card information for each slot with the rate of a correction value obtained by adding a predetermined minimum value greater than 0 to the number of selections. FIG. 14 illustrates an example of the number of selections for each slot in a certain day with respect to a program having a service type of broadcast. For example, the numbers of selections of a genre, a cast and regularity from 09:00 to 09:30 are 9, 0 and 5. The card creation/filing unit 121 calculates correction values 11, 2 and 7 by adding 2 as an example of a correction value to the respective selection values. In addition, the card creation/filing unit 121 determines an upper limit of card information for each recommendation type by proportionally dividing the upper limit of the number determined for the corresponding slot with the ratio of 11:2:7 for the genre, cast and regularity.

A value obtained by proportional division may not be n integer value. In such a case, the card creation/filing unit 121 may randomly allocate a predetermined number of pieces of recommendation content for recommendation types in the corresponding slot such that the proportion of correction values becomes the proportion of appearance probabilities, as described using FIG. 6. Further, the card creation/filing unit 121 may determine an upper limit of the number of pieces of card information the same as for time periods such that the number increases for a recommendation content type in which the number of selections is large for all time periods of each day.

### (Content Addition Time Period)

Next, an example of a content addition time period determined based on life time period information will be described.

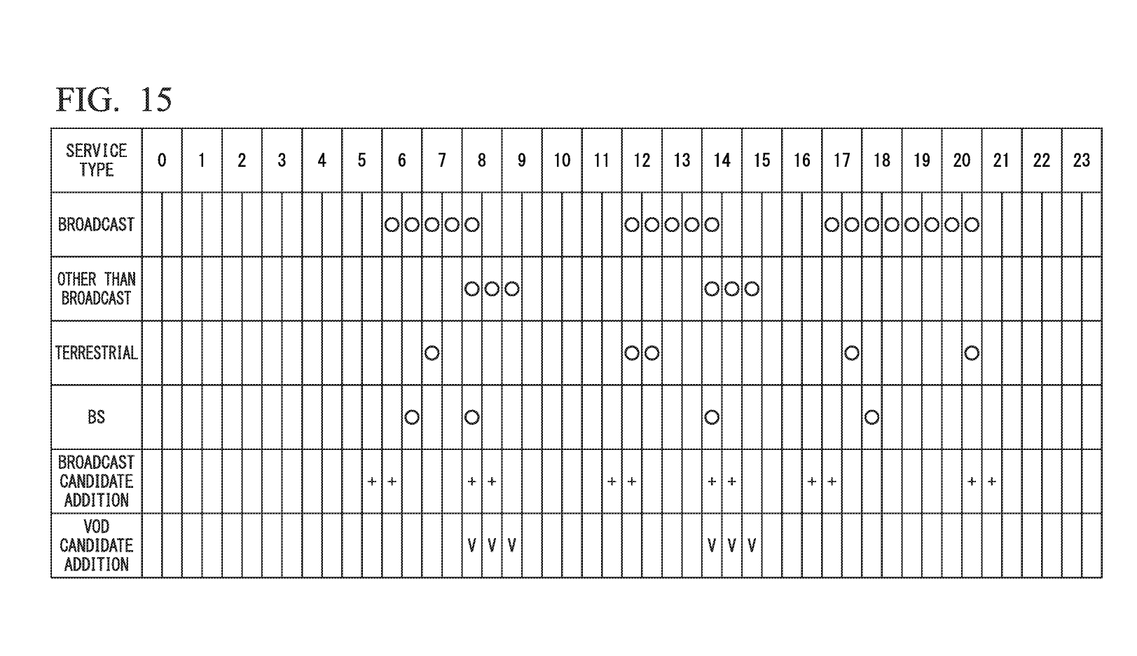

A content addition time period is a slot in which the card creation/filing unit 121 determines an upper limit of the number of pieces of content as a larger number than in other slots. FIG. 15 is a diagram illustrating an example of life time period information and a content addition time period. The second to fifth rows in FIG. 15 represent service types and the sixth and seventh rows represent content addition time periods. Service types include broadcast, other than broadcast, terrestrial broadcast and BS broadcast. The terrestrial broadcast and BS broadcast are a kind of broadcast. Symbol “∘” represents a viewing time period. Viewing time periods with respect to broadcast are 6:00 to 8:30, 12:00 to 14:30 and 17:00 to 21:00. Symbols + and v represent content addition time periods. For example, the slot from 5:30 to 6:00 denoted by symbol + is not a slot which is not a viewing time period, and the slot from 6:00 to 6:30 is a slot which is a viewing time period, and thus determination of whether a slot is a viewing time period is different for the neighboring slots. The slot from 8:00 to 9:30 denoted by symbol v is a slot determined to be a viewing time period with respect to content having a service type of other than broadcast.

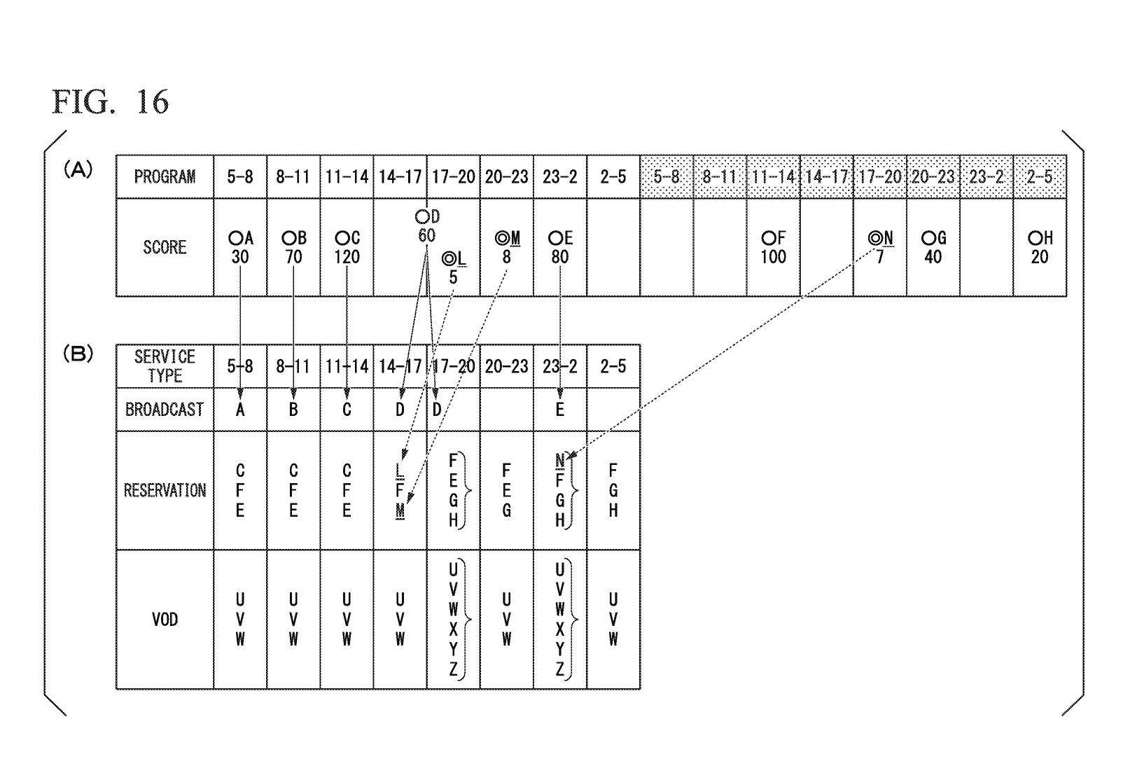

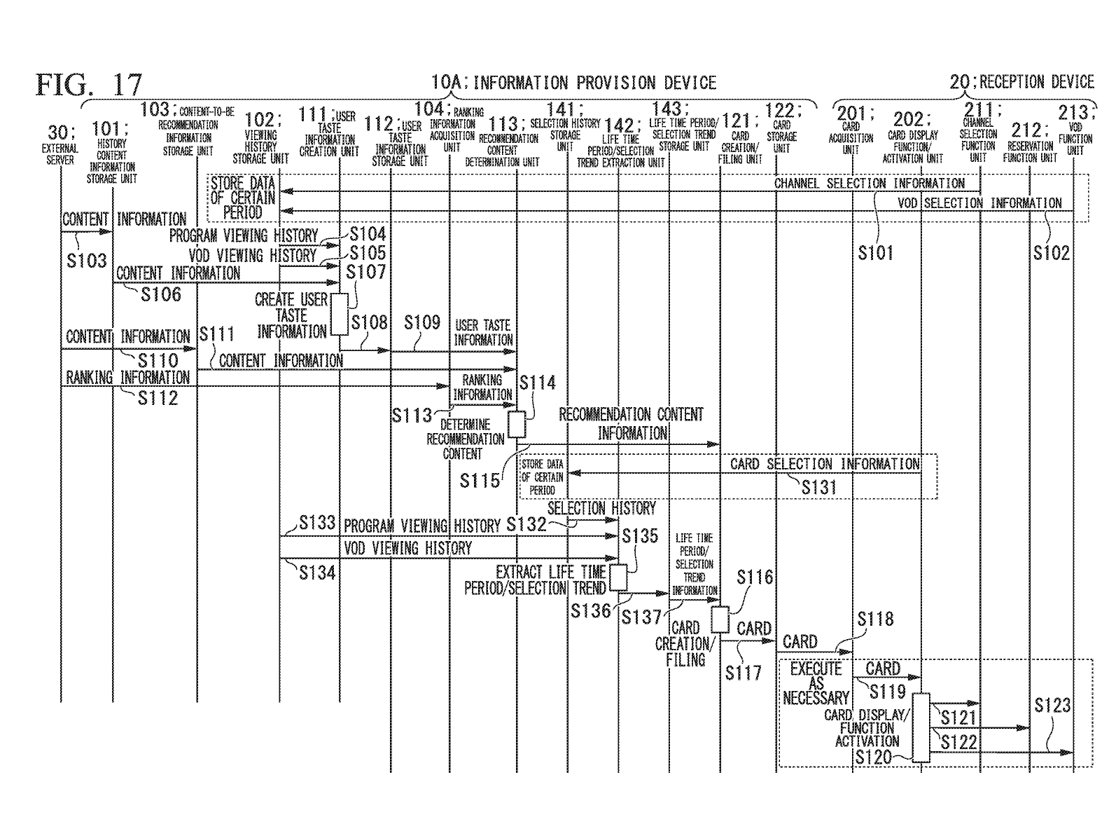

Next, an example of selecting recommendation content in the card creation/filing unit 121 will be described. FIG. 16 is a diagram illustrating an example of selecting recommendation content. In the example illustrated in FIG. 16, the length of each slot is 3 hours. In addition, upper limits of the numbers of pieces of card information with respect to broadcast, reservation and VOD as service types are 1, 3 and 3, respectively. In addition, the slot from 14:00 to 17:00 and the slot from 23:00 to 02:00 next day are set as ranking base time periods, and the slot from 17:00 to 20:00 and the slot from 23:00 to 02:00 next day are set as content addition time periods. In the content addition time periods, the upper limit of the number of pieces of card information with respect to each of reservation and VOD as service types is 6.

FIG. 16(A) shows a program selected as candidate content for each slot and a score. 5-8, 8-11 and the like represent start times and end times of slots. A, B and the like are sings for identifying content. Symbols ∘ and © respectively represent a program selected on the viewing trend base and a program selected on the ranking base.

FIG. 16(B) shows content selected as recommendation content for each slot. Each row in FIG. 16(B) represents a service type. FIG. 16(B) shows that a program broadcast in a slot is selected as recommendation content having a service type of broadcast. For example, program A which is candidate content of the slot from 5:00 to 8:00 is selected as recommendation content. In addition, program D having a broadcast time extending from the slot from 14:00 to 17:00 and the slot from 17:00 to 20:00 is selected as recommendation content in each slot.

Among programs which start to be broadcast in the future after start times of corresponding slots as recommendation content having a service type of reservation, a program having a higher score is preferentially selected. For example, in the slot from 5:00 to 8:00, program C having the highest score of 120, program F having the second height score of 100 and program E having the third highest score among programs which start to be broadcast after 5:00 are selected as recommendation content in the slot. With respect to the slot from 14:00 to 17:00 set as a ranking base time period, programs L and M which will broadcast in the future, selected on the ranking base, are selected as recommendation content. Program N which will be broadcast in the future is not selected because program N is not within the effective period in the slot.

In the slot from 17:00 to 20:00 which is a content addition time period, four programs F, E, G and H which will be broadcast in the future are selected as recommendation content. At this point in time, there are four programs which will be broadcast in the future as candidate content, the set upper limit of 6 is not satisfied. On the contrary, six pieces of VOD content U, V, W, X, Y and Z are selected as recommendation content in this slot.

### (Information Provision Procedure)

Next, an information provision procedure according to the present embodiment will be described. FIG. 17 is a sequence diagram illustrating the information provision procedure according to the present embodiment. The procedure illustrated in FIG. 17 includes processes of steps S131 to S137 in addition to the processes of steps S101 to S123. The process of step S131 is performed as necessary according to execution of the processes of steps S121 to S123.

(Step S131) The card display function/activation unit 202 of the reception device 20 transmits card selection information including a time at which content has been selected, recommendation type information extracted from card information and identification information of recommendation content to the information provision device 10A.

The selection history storage unit 141 of the information provision device 10A stores the received card selection information for a certain period for each reception device 20 to form a selection history.

(Step S132) The life time period/selection trend extraction unit 142 reads a selection history in a predetermined period for each reception device 20 from the selection history storage unit 141. Then, the procedure proceeds to the process of step S133.

(Step S133) The life time period/selection trend extraction unit 142 reads a program viewing history as a viewing history in a predetermined period for each reception device 20 from the viewing history storage unit 102. Then, the procedure proceeds to the process of step S134.

(Step S134) The life time period/selection trend extraction unit 142 reads a VOD viewing history as a viewing history in a predetermined period for each reception device 20 from the viewing history storage unit 102. Then, the procedure proceeds to the process of step S135.

(Step S135) The life time period/selection trend extraction unit 142 determines whether each slot of each day is a viewing time period in which the proportion of a viewing time of content is greater than a predetermined proportion based on the viewing history for each service type. The life time period/selection trend extraction unit 142 creates life time period information including flag information indicating a viewing time period for each service type. The life time period/selection trend extraction unit 142 counts the number of selections of content for recommendation type for each slot of each day with reference to the selection history. The life time period/selection trend extraction unit 142 creates selection trend information indicating the counted number of selections. Then, the procedure proceeds to the process of step S136.

(Step S136) The life time period/selection trend extraction unit 142 stores the created life time period information and selection trend information in the life time period/selection trend storage unit 143. Then, the procedure proceeds to the process of step S137.

(Step S137) The card creation/filing unit 121 reads life time period information for each reception device 20 from the life time period/selection trend storage unit 143. With respect to a slot having a different determination of whether the slot is a viewing time period from temporally adjacent slots for broadcast, the card creation/filing unit 121 determines an upper limit of the number of pieces of card information about broadcast as a service type as a larger value than in other slots with reference to the read life time period information. With respect to a slot determined to be a viewing time period of content other than broadcast, the card creation/filing unit 121 determines an upper limit of the number of pieces of card information about VOD as a service type as a larger value in other slots with reference to the read life time period information.

The card creation/filing unit 121 reads selection trend information for each reception device 20 from the life time period/selection trend storage unit 143. The card creation/filing unit 121 determines an upper limit of the number of pieces of card information, that is, the number of pieces of recommendation content such that the number increases for a recommendation type having a larger number of selections for each slot of each day with reference to the selection trend information. Then, the procedure proceeds to the process of step S116.

As described above, the information provision device 10A according to the present embodiment includes the life time period/selection trend extraction unit 142 as an analysis unit which analyzes the quantity of reception of received content for each time period based on a viewing history. The card creation/filing unit 121 determines the number of pieces of recommendation content based on the analyzed quantity of reception.

According to this configuration, the number of pieces of recommendation content which may be received is determined according to the quantity of reception for each time period of the user. For example, the number of pieces of recommendation content may be increased in a time period having a larger quantity of viewing such that the user is able to view various types of content. Accordingly, it is possible to improve satisfaction of the user.

In addition, with respect to recommendation content having a service type of broadcast, the card creation/filing unit 121 sets the number of pieces of recommendation content in a time period in which a temporal variation in the quantity of reception is greater than a predetermined temporal variation as a larger value than the number of pieces of recommendation content in other time periods.

According to this configuration, a lot of recommendation content is selected in a time period in which there is a large temporal variation in the quantity of reception. Such a time period is highly likely to include a viewing start time or a viewing end time at which the user determines initiation or continuation of viewing. Accordingly, in such a time period, the user is able to view various types of content and thus satisfaction of the user can be improved.

Furthermore, the card creation/filing unit 121 increases, in a time period having a larger quantity of reception of received content having a service type other than broadcast, the number of pieces of recommendation content in this time period with respect to recommendation content having a service type of VOD.

According to this configuration, a larger amount of recommendation content of a predetermined service type is selected in a time period having a larger quantity of reception of received content of a service type other than broadcast. In such a time period, the user is able to view various types of content of the service type. Accordingly, satisfaction of the user is improved and the user is induced to view recommendation content of the service type.

Moreover, the card creation/filing unit 121 increases the number of pieces of recommendation content selected using an attribute used by the recommendation content determination unit 113 to select candidate content as the quantity of reception of content having the attribute increases.

According to this configuration, a lot of recommendation content having an attribute the same as for frequently viewed content is selected. The user is able to view a lot of recommendation content suitable for their taste and thus satisfaction of the user is improved.

Although an embodiment of the present invention has been described in detail with reference to the drawings, detailed configurations are not limited thereto and may be modified in design in various manners without departing from the spirit of the present invention. For example, the components described in the above embodiments may be arbitrarily combined.

Although cases in which content which is a processing target is mainly a program and VOD content have been exemplified in the above-described embodiments, the present invention is not limited thereto. Other types of content may be processing targets. For example, electronic advertisement which can be transmitted and received through the network NW and other types of guide information may be processing targets. With respect to such content, an image of information on the content is not displayed on the display unit 222 in a period other than the effective period and is displayed within the effective period, and thus unnecessary accessing to content relating to an image which is not displayed can be avoided.

In addition, one or both of the person detection unit 221 and the display unit 222 of the reception device 20 may be separate bodies if various types of data can be transmitted and received between the person detection unit 221 and the display unit 222, and other parts of the reception device 20.

The shape of an image displayed on the display unit 222 is not limited to the card type. For example, the shape may be a button type, a thumbnail type and the like. Further, the number of such images and details of service types may be arbitrarily set.

Furthermore, in the above-described embodiments, a device ID for identifying the individual reception device 20 may be used instead of the user ID. In addition, although examples in which processing of each part constituting the information provision devices 10 and 10A and the reception device 20 is performed with respect to each reception device 20 have been described in the above embodiments, the present invention is not limited thereto. Processing of each part may be performed for each user of each reception device 20. In such a case, the person detection unit 221 of the reception device 20 identifies each user. For example, the person detection unit 221 includes a photographing unit which captures surrounding images and an image processing unit which performs a known image recognition process on an image captured by the photographing unit to identify a user represented in the image.

Moreover, the components included in the above-described external server 30 may be arranged in such a manner that they are distributed or aggregated in any number of computer devices. For example, the program integration server, the VOD content integration server, the ranking server and the VOD content server may be distributed or aggregated in any computer devices according to network environment, scale of the number of users, the number of pieces of hardware provided to constitute the information provision system 1, specification and the like. Some or all of the program integration server, the VOD content integration server, the ranking server and the VOD content server may be configured as an independent integrated server device or integrated as part of the information provision device 10.

Meanwhile, some of the above-described aspects of the present invention may also be embodied as the following aspects.

(1) An information provision device including a determination unit which determines candidates for recommendation content from content scheduled to be transmitted based on a viewing history of received content received by a reception device, and a creation unit which determines an effective period corresponding to the service type of a reception service of the recommendation content and transmits recommendation content information created including the effective period to the reception device.

(2) The information provision device of (1) wherein the creation unit selects a predetermined number of pieces of recommendation content from the candidates for each unit time.

(3) The information provision device of (1) or (2) wherein the determination unit selects content having an attribute the same as for the received content as the candidates and determines scores of the candidates according to degrees of the attribute, and the creation unit selects a predetermined number of pieces of recommendation content from the candidates for each unit time based on the scores.

(4) The information provision device of (3) including an analysis unit which analyzes the quantity of reception of the received content for each time period based on the viewing history, wherein the creation unit determines the number of pieces of the recommendation content based on the quantity of reception.

(5) The information provision device of (4) wherein, with respect to recommendation content having a service type corresponding to broadcast, the creation unit sets the number of pieces of recommendation content in a time period in which a temporal variation in the quantity of reception is greater than a predetermined temporal variation to be greater than the number of pieces of recommendation content in other time periods.

(6) The information provision device of (4) or (5) wherein, for a time period having a larger quantity of reception of received content having a service type other than broadcast, the creation unit increases the number of pieces of recommendation content in the time period, with respect to recommendation content having a service type corresponding to video on demand.

(7) The information provision device of any one of (2) to (6) wherein the creation unit increases the number of pieces of recommendation content as the quantity of reception of content having the attribute used by the determination unit to select the candidates increases.

(8) A reception device including a function unit which receives content, an acquisition unit which acquires recommendation content information including an effective period of recommendation content, and a control unit which controls whether to output an image representing the recommendation content according to whether the current time is in the effective period and causes the function unit to receive the recommendation content according to an instruction for the image.

(9) An information provision system including an information provision device and a reception device, wherein the information provision device includes a determination unit which determines candidates for recommendation content from content scheduled to be transmitted based on a viewing history of received content received by the reception device, and a creation unit which determines an effective period corresponding to the service type of a reception service of the recommendation content and transmits recommendation content information created including the effective period to the reception device, and the reception device includes a function unit which receives content, an acquisition unit which acquires recommendation content information including an effective period of recommendation content, and a control unit which controls whether to output an image representing the recommendation content according to whether the current time is in the effective period and causes the function unit to receive the recommendation content according to an instruction for the image.

(10) An information provision method in an information provision device, including a determination step of determining candidates for recommendation content from content scheduled to be transmitted based on a viewing history of received content received by a reception device, and a creation step of determining an effective period corresponding to the service type of a reception service of the recommendation content and transmitting recommendation content information created including the effective period to the reception device.

(11) An information provision program which causes a computer of an information provision device to execute a determination procedure of determining candidates for recommendation content from content scheduled to be transmitted based on a viewing history of received content received by a reception device, and a creation procedure of determining an effective period corresponding to the service type of a reception service of the recommendation content and transmitting recommendation content information created including the effective period to the reception device.

Meanwhile, at least some functions of the information provision devices 10 and 10A or the reception device 20 in the above-described embodiments may be realized by a computer. In such a case, a program for realizing the functions may be recorded in a computer-readable recording medium, and a computer system is caused to read and execute the program recorded in the recording medium. Meanwhile, “computer system” mentioned here is a computer system embedded in the information provision devices 10 and 10A or the reception device 20 and includes hardware such as an OS and peripheral devices. In addition, “computer readable recording medium” refers to portable media such as a flexible disc, a magneto-optical disc, a ROM and a CD-ROM and storage devices such as a hard disk embedded in computer systems. Furthermore, “computer readable storage medium” may also include a medium which dynamically holds a program for a short time such as a communication line in a case in which the program is transmitted through a network such as the Internet or a communication line such as a telephone line, and a medium which holds a program for a specific time, such as a volatile memory in a computer system serving as a server or a client in that case. In addition, the aforementioned program may be a program for realizing some of the above-described functions and may be a program capable of realizing the aforementioned functions by combining the functions with a program recorded in a computer system.

Moreover, the entire or part of the information provision devices 10 and 10A or the reception device 20 in the above-described embodiments may be realized as an integrated circuit such as a large scale integration (LSI). Each functional block of the information provision devices 10 and 10A or the reception device 20 may be individually realized as a processor, or some or all thereof may be integrated into a processor. Further, a method for realizing the integrated circuit is not limited to LSI, and the integrated circuit may be realized as a dedicated circuit or a general-purpose processor.

In addition, when a circuit integration technology which replaces LSI appears with the development of semiconductor technology, an integrated circuit according to the technology may be used.

### INDUSTRIAL APPLICABILITY

Several embodiments of the present invention may be applied to information provision devices, reception devices, information provision systems, information provision methods, programs and the like which need to reliably receive content represented by a display image.

### DESCRIPTION OF THE REFERENCE SYMBOLS

1, 1A . . . Information provision system

10, 10A . . . Information provision device

20 . . . Reception device

30 . . . External server

101 . . . History content information storage unit

102 . . . Viewing history storage unit

103 . . . Content-to-be recommendation information storage unit

104 . . . Ranking information acquisition unit

111 . . . User taste information creation unit

112 . . . User taste information storage unit

113 . . . Recommendation content determination unit

121 . . . Card creation/filing unit

122 . . . Card storage unit

131 . . . Communication unit

141 . . . Selection history storage unit

142 . . . Life time period/selection trend extraction unit

143 . . . Life time period/selection trend storage unit

201 . . . Card acquisition unit

202 . . . Card display function/activation unit

203 . . . Card display control unit

204 . . . Function control unit

211 . . . Channel selection function unit

212 . . . Reservation function unit

213 . . . VOD function unit

221 . . . Person detection unit

222 . . . Display unit

223 . . . Input unit

231 . . . Communication unit

232 . . . Broadcast reception unit

NW . . . Network

1. An information provision device comprising:
a determination unit which determines candidates for recommendation content from content scheduled to be transmitted based on a viewing history of received content received by a reception device; and
a creation unit which determines an effective period corresponding to the service type of a reception service of the recommendation content and transmits recommendation content information created including the effective period to the reception device.

2. The information provision device according to claim 1,
wherein the creation unit selects a predetermined number of pieces of recommendation content from the candidates for each unit time.

3. The information provision device according to claim 1,
wherein the determination unit selects content having an attribute the same as for the received content as the candidates and determines scores of the candidates according to degrees of the attribute, and
the creation unit selects a predetermined number of pieces of recommendation content from the candidates for each unit time based on the scores.

4. The information provision device according to claim 3, comprising an analysis unit which analyzes the quantity of reception of the received content for each time period based on the viewing history,
wherein the creation unit determines the number of pieces of the recommendation content based on the quantity of reception.

5. The information provision device according to claim 4,
wherein, with respect to recommendation content having a service type corresponding to broadcast, the creation unit sets the number of pieces of recommendation content in a time period in which a temporal variation in the quantity of reception is greater than a predetermined temporal variation to be greater than the number of pieces of recommendation content in other time periods.

6. The information provision device according to claim 4,
wherein, for a time period having a larger quantity of reception of received content having a service type other than a broadcast, the creation unit increases the number of pieces of recommendation content in the time period, with respect to recommendation content having a service type corresponding to video on demand.

7. The information provision device according to claim 2,
wherein the creation unit increases the number of pieces of recommendation content as the quantity of reception of content having the attribute used by the determination unit to select the candidates increases.

8. A reception device comprising:
a function unit which receives content,
an acquisition unit which acquires recommendation content information including an effective period of recommendation content; and
a control unit which controls whether to output an image representing the recommendation content according to whether the current time is in the effective period and causes the function unit to receive the recommendation content according to an instruction for the image.

9. An information provision system comprising:
an information provision device; and
a reception device,
wherein the information provision device includes
a determination unit which determines candidates for recommendation content, from content scheduled to he transmitted based on a viewing history of received content received by the reception device, and
a creation unit which determines an effective period corresponding to the service type of a reception service of the recommendation content and transmits recommendation content information created including the effective period to the reception device, and
the reception device includes
a function unit which receives content,
an acquisition unit which acquires recommendation content information including an effective period of recommendation content, and
a control unit which controls whether to output an image representing the recommendation content according to whether the current time is in the effective period and causes the function unit to receive the recommendation content according to an instruction for the image.

10. An information provision method in an information provision device, the information provision method comprising:
determining candidates for recommendation content from content scheduled to be transmitted based on a viewing history of received content received by a reception device; and
determining an effective period corresponding to the service type of a reception service of the recommendation content and transmitting recommendation content information created including the effective period to the reception device.

11. A non-transitory recording medium storing an information provision program which causes a computer of an information provision device to execute:
determining candidates for recommendation content from content scheduled to be transmitted based on a viewing history of received content received by a reception device; and
determining an effective period corresponding to the service type of a receptio service of the recommendation content and transmitting recommendation content infortnation created including the effective period to the reception device.
